(19) United States
(12) Patent Application Publication
(10) Pub. No.: US 2026/0335764 A1
(43) Pub. Date: Oct. 29, 2026

(54) VIRTUAL CHARACTER CAPTURE

(71) Applicant: Tencent Technology (Shenzhen) Company Limited, Shenzhen (CN)

(72) Inventor: Xiusheng SONG, Shenzhen (CN)

(73) Assignee: Tencent Technology (Shenzhen) Company Limited, Shenzhen (CN)

(21) Appl. No.: 19/681,031

(22) Filed: May 18, 2026

Related U.S. Application Data
(63) Continuation of application No. PCT/CN2025/103124, filed on Jun. 24, 2025.

(30) Foreign Application Priority Data
Aug. 5, 2024 (CN) 202411068752.1

(51) Int. Cl. A63F 13/537; A63F 13/2145; A63F 13/56; A63F 13/825

(52) U.S. Cl. CPC A63F 13/537; A63F 13/2145; A63F 13/56; A63F 13/825

(57) ABSTRACT

In a method of capturing a virtual pet character in a virtual environment, a virtual main character and the virtual pet character are displayed in the virtual environment of a game application. The virtual main character is controlled by a user. A capture prop control element is displayed in a game interface of the game application. The capture prop control element is configured to control the virtual main character to initiate capture of the virtual pet character. A release operation that is performed by the user on the capture prop control element is received. Based on the release operation, a capture effect on the virtual pet character is displayed, a capture result of the virtual pet character is determined, and the capture result of the virtual pet character is displayed.

### CROSS-REFERENCE TO RELATED APPLICATIONS

The present application is a continuation of International Application No. PCT/CN2025/103124, filed on Jun. 24, 2025, which claims priority to Chinese Patent Application No. 202411068752.1, filed on Aug. 5, 2024, and entitled “CAPTURE METHOD AND APPARATUS BASED ON VIRTUAL WORLD, DEVICE, MEDIUM, AND PRODUCT.”The entire disclosures of the prior applications are hereby incorporated by reference.

### FIELD OF THE TECHNOLOGY

Embodiments of this disclosure relate to the field of human-computer interaction, including a capture method and apparatus based on a virtual world, a device, a medium, and a product.

### BACKGROUND OF THE DISCLOSURE

A role-playing game (RPG) is a game type. In this type of game, a player controls a main control virtual character to explore or perform activities in a virtual world. The player controls the main control virtual character to capture (tame) a virtual pet character in the virtual world, and then raises the virtual pet character or uses the virtual pet character to perform interaction such as fighting.

In a related technology, when capturing the virtual pet character, the player may control the main control virtual character to use a capture prop, aim the capture prop at the virtual pet character, and throw the capture prop, so that the thrown capture prop captures the virtual pet character after flying in the air or rolling on the ground for a distance.

However, the manner of taming the virtual pet character by using the capture prop in the related technology requires the player to throw out the capture prop after manual aiming, and a flight path of the capture prop is affected by environmental factors (such as a wind direction, gravity, and collision detection), making it more difficult to accurately hit the virtual pet character.

### SUMMARY

This disclosure includes a capture method and apparatus based on a virtual world, a device, a medium, and a product. Technical solutions including the following.

According to an aspect of this disclosure, a method of capturing a virtual pet character in a virtual environment is provided. In the method, a virtual main character and the virtual pet character are displayed in the virtual environment of a game application. The virtual main character is controlled by a user. A capture prop control element is displayed in a game interface of the game application. The capture prop control element is configured to control the virtual main character to initiate capture of the virtual pet character. A release operation that is performed by the user on the capture prop control element is received. Based on the release operation, a capture effect on the virtual pet character is displayed, a capture result of the virtual pet character is determined, and the capture result of the virtual pet character is displayed.

According to an aspect of this disclosure, an information processing apparatus is provided. The information processing apparatus includes processing circuitry configured to display a virtual main character and a virtual pet character in a virtual environment of a game application, the virtual main character being controlled by a user. The processing circuitry is configured to display a capture prop control element in a game interface of the game application, the capture prop control element being configured to control the virtual main character to initiate capture of the virtual pet character. The processing circuitry is configured to receive a release operation that is performed by the user on the capture prop control element. Based on the release operation, the processing circuitry is configured to display a capture effect on the virtual pet character, determine a capture result of the virtual pet character, and display the capture result of the virtual pet character.

According to an aspect of this disclosure, a non-transitory computer-readable storage medium is provided. The non-transitory computer-readable storage medium storing instructions which when executed by a processor cause the processor to perform any of the methods of capturing a virtual pet character.

According to an aspect of this disclosure, a capture method based on a virtual world is provided. The method is performed by a computer device, and includes: displaying at least one of a main control virtual character or a virtual pet character located in the virtual world; displaying a capture prop control, the capture prop control being a control configured for controlling the main control virtual character to capture the virtual pet character; receiving a release operation on the capture prop control; and displaying a capture spell-casting effect cast by the main control virtual character on the virtual pet character and a capture result of the virtual pet character in response to the release operation.

According to an aspect of this disclosure, a capture apparatus based on a virtual world is provided. The apparatus includes: a display module, configured to display at least one of a main control virtual character or a virtual pet character located in the virtual world, the display module being configured to display a capture prop control, the capture prop control being a consumption control configured for controlling the main control virtual character to capture the virtual pet character; and a receiving module, configured to receive a release operation on the capture prop control, the display module being configured to display a capture spell-casting effect cast by the main control virtual character on the virtual pet character and a capture result of the virtual pet character in response to the release operation.

According to another aspect of this disclosure, a computer device is provided. The computer device includes a processor and a memory. The memory has at least one computer program stored therein. The at least one computer program is loaded and executed by the processor to implement the capture method based on a virtual world described in the foregoing aspect.

According to another aspect of this disclosure, a computer-readable storage medium is provided. The computer-readable storage medium has at least one computer program stored therein. The at least one computer program is loaded and executed by a processor to implement the capture method based on a virtual world described in the foregoing aspect.

According to another aspect of this disclosure, a computer program product is provided. The computer program product includes a computer program. The computer program is stored in a computer-readable storage medium. The computer program is read from the computer-readable storage medium and executed by a processor of a computer device, to enable the computer device to perform the capture method based on a virtual world described in the foregoing aspect.

Technical solutions provided in the embodiments of this disclosure can have at least the following beneficial effects.

The main control virtual character and at least one virtual pet character in a scene picture of the virtual world are displayed, and the player may determine, based on a requirement, whether to capture the virtual pet character. The release operation on the capture prop control is triggered to display the capture spell-casting effect of the main control virtual character on the virtual pet character, and after the main control virtual character completes casting a spell on the virtual pet character, the capture result of the virtual pet character is displayed. This manner of capturing the virtual pet character by casting the spell simplifies operations of capturing the virtual pet character without considering impact of environmental factors on the capture, reducing difficulty in pet capture, enhancing immersion and entertainment of pet capture, and improving user engagement and satisfaction. In addition, high-precision capture based on triggering of the capture prop control also conforms to a trigger intention of the player, avoids an error caused by a related manual capture operation, improves a success rate of capturing the virtual pet character, and enables the player to smoothly and pertinently perform a capture operation, reducing a quantity of ineffective operations of capturing the virtual pet character and improving human-computer interaction efficiency.

### BRIEF DESCRIPTION OF THE DRAWINGS

FIG. 1 is a schematic diagram of a structure of a computer system according to an embodiment of this disclosure.

FIG. 2 is a schematic diagram of a capture method based on a virtual world according to an embodiment of this disclosure.

FIG. 3 is a flowchart of a capture method based on a virtual world according to an embodiment of this disclosure.

FIG. 4 is a schematic diagram of a capture method based on a virtual world according to an embodiment of this disclosure.

FIG. 5 is a flowchart of a capture method based on a virtual world according to an embodiment of this disclosure.

FIG. 6 is a schematic diagram of a capture method based on a virtual world according to an embodiment of this disclosure.

FIG. 7 is a schematic diagram of a capture method based on a virtual world according to an embodiment of this disclosure.

FIG. 8 is a schematic diagram of a capture spell-casting effect according to an embodiment of this disclosure.

FIG. 9 is a schematic diagram of a capture spell-casting effect according to an embodiment of this disclosure.

FIG. 10 is a schematic diagram of a capture spell-casting effect according to an embodiment of this disclosure.

FIG. 11 is a flowchart of a capture method based on a virtual world according to an embodiment of this disclosure.

FIG. 12 is a flowchart of a capture method based on a virtual world according to an embodiment of this disclosure.

FIG. 13 is a flowchart of a capture method based on a virtual world according to an embodiment of this disclosure.

FIG. 14 is a schematic diagram of a capture method based on a virtual world according to an embodiment of this disclosure.

FIG. 15 is a schematic diagram of a capture method based on a virtual world according to an embodiment of this disclosure.

FIG. 16 is a schematic diagram of a capture method based on a virtual world according to an embodiment of this disclosure.

FIG. 17 is a schematic diagram of a capture method based on a virtual world according to an embodiment of this disclosure.

FIG. 18 is an overall flowchart of a capture method based on a virtual world according to an embodiment of this disclosure.

FIG. 19 is a diagram of comparison between results obtained in a related technology and this solution according to an embodiment of this disclosure.

FIG. 20 is a block diagram of a structure of a capture apparatus based on a virtual world according to an embodiment of this disclosure.

FIG. 21 is a schematic diagram of a structure of a computer device according to an embodiment of this disclosure.

### DETAILED DESCRIPTION

Descriptions of terms in this disclosure are provided as examples only and are not intended to limit the scope of the disclosure.

Related terms in this disclosure are described below.
Virtual world: may refer to a virtual environment displayed (or provided) when an application is run on a terminal.
Main control virtual character: may refer to a movable object played by a player, or user, in a virtual world.
Virtual pet character: may refer to a movable object controlled by artificial intelligence (AI) in a virtual world. The virtual pet character may be a virtual creature, a virtual animal, a virtual monster, a virtual sprite, a virtual pet, or the like.

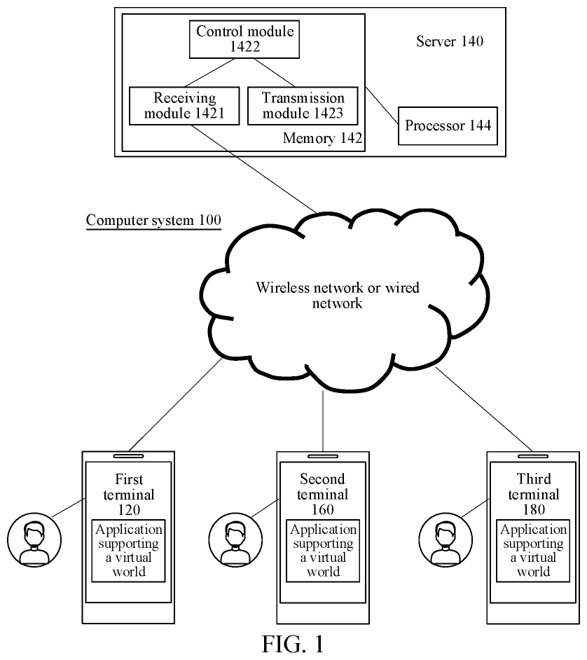

Referring to FIG. 1, a block diagram of a structure of a computer system according to an embodiment of this disclosure is shown. The computer system 100 includes a first terminal 120, a server 140, a second terminal 160, and a third terminal 180.

A client of an application supporting a virtual world is installed and run on the first terminal 120. The application may be any one of a three-dimensional map program, a virtual reality (VR) application, an augmented reality (AR) program, an RPG program, a turn-based game program, or a turn-based RPG program. The first terminal 120 is a terminal used by a first user. The first user controls, by using the first terminal 120, a first virtual character located in a virtual world to perform an activity. The first virtual character is used as a main control virtual character. The activity includes but is not limited to at least one of adjusting a body posture, walking, running, jumping, riding, driving, aiming, picking up, capturing a virtual pet character, controlling the virtual pet character, raising the virtual pet character, using the virtual pet character to pick, using the virtual pet character to combat, using a throwing prop, or attacking another virtual character. For example, the first virtual character is a first virtual person, for example, a simulated person object or a cartoon person object. For example, the first user controls, by using a UI control in a virtual world picture, the first virtual character to perform the activity, and the first user controls, by using the UI control in the virtual world picture, the first virtual character to throw the virtual pet character.

The first terminal 120 is connected to the server 140 through a wireless network or a wired network.

The server 140 includes at least one of one server, a plurality of servers, a cloud computing platform, or a virtualization center. For example, the server 140 includes a processor 144 and a memory 142. The memory 142 further includes a receiving module 1421, a control module 1422, and a transmission module 1423. The receiving module 1421 is configured to receive a request transmitted by the client, for example, a location request for viewing a location of an enemy virtual character. The control module 1422 is configured to control rendering of a virtual world picture. The transmission module 1423 is configured to transmit a response to the client, for example, transmit a location of a third virtual character to the client. The server 140 is configured to provide a backend service for an application supporting a three-dimensional virtual world. In some embodiments, the server 140 is in charge of primary computing works, and the first terminal 120, the second terminal 160, and the third terminal 180 are in charge of secondary computing works. Alternatively, the server 140 is in charge of secondary computing works, and the first terminal 120, the second terminal 160, and the third terminal 180 are in charge of primary computing works. Alternatively, the server 140, the first terminal 120, the second terminal 160, and the third terminal 180 perform collaborative computing by using a distributed computing architecture.

A client of an application supporting a virtual world is installed and run on the second terminal 160. The second terminal 160 is a terminal used by a second user. The second user controls, by using the second terminal 160, a second virtual character in the virtual world to perform an activity. The second virtual character is also used as a main control virtual character. An application supporting a virtual world is installed and run on the third terminal 180. The third terminal 180 is a terminal used by a third user. The third user controls, by using the third terminal 180, the third virtual character in the virtual world to perform an activity.

In some embodiments, the first virtual character, the second virtual character, and the third virtual character are in a same virtual world. The first virtual character and the second virtual character belong to different camps, and the second virtual character and the third virtual character belong to a same camp.

In some embodiments, the applications installed on the first terminal 120, the second terminal 160, and the third terminal 180 are the same, or the applications installed on the three terminals are applications of a same type on different operating system platforms (Android or iOS). The first terminal 120 may refer to one of a plurality of terminals, the second terminal 160 may refer to one of the plurality of terminals, and the third terminal 180 may refer to one of the plurality of terminals. In this embodiment, the first terminal 120, the second terminal 160, and the third terminal 180 are used merely as an example for description. Device types of the first terminal 120, the second terminal 160, and the third terminal 180 are the same or different. The device type includes at least one of a smartphone, a smartwatch, a smart television, a tablet computer, an e-book reader, an MP3 player, an MP4 player, a laptop computer, or a desktop computer. In the following embodiment, an example in which the terminal includes a smartphone is used for description. A person skilled in the art may understand that there may be more or fewer terminals. For example, there may be only one terminal, or there are dozens of, hundreds of, or more terminals. A quantity and device types of terminals are not limited in the embodiments of this disclosure.

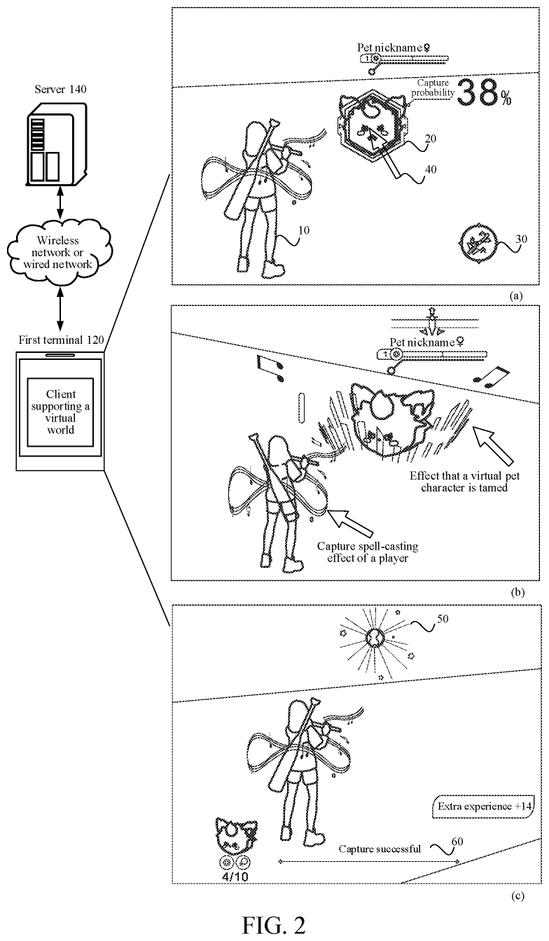

For example, referring to FIG. 2, a schematic diagram of a capture method based on a virtual world according to an embodiment of this disclosure is shown. An example in which the method is performed by a client supporting a virtual world is used for description. For example, the client supporting a virtual world is deployed on the first terminal 120 (or may be deployed on a terminal such as the second terminal 160 or the third terminal 180, which is not limited herein).

In view of the foregoing problem, an embodiment of this disclosure provides a capture method based on a virtual world. The method may be performed by a terminal device or a client on a terminal device. After a game starts, a capture prop control is displayed on the client. For example, the capture prop control is a capture prop button. A player controls a main control virtual character to trigger the capture prop control, with an aiming reticle in a guidance form appearing, and aligns the aiming reticle with a to-be-captured virtual pet character. In this case, a capture probability is displayed around the virtual pet character, and the player may determine, based on the capture probability, whether to capture the virtual pet character. In some embodiments, the player releases the capture prop control. In this case, the main control virtual character starts to execute a spell-casting effect on the virtual pet character, and the virtual pet character presents a taming effect corresponding to the spell-casting effect. When the main control virtual character completes casting a spell under the control of the player, a capture result (including a capture success or a capture failure) of the virtual pet character is displayed.

For example, as shown in (a) in FIG. 2, a scene picture in which a main control virtual character 10 is located in the virtual world is displayed on the client. The scene picture further includes at least one to-be-captured virtual pet character 20. The virtual pet character 20 is a movable object in the virtual world. In some embodiments, the main control virtual character 10 may perform at least one of interactive operations such as capturing, raising, and upgrading on the virtual pet character 20. This is not limited in this disclosure. In some embodiments, the virtual pet character 20 may assist the main control virtual character 10 in, but not limited to, at least one of interactive operations such as collection, combating, and changing a tile. This is not limited in this disclosure. As shown in (a) in FIG. 2, a capture prop control 30 is further displayed in the scene picture. The capture prop control is a control used by the main control virtual character 10 to control the virtual pet character 20. An aiming reticle 40 corresponding to the capture prop control 30 is displayed in the scene picture in response to a touch operation on the capture prop control 30. The aiming reticle 40 is configured for assisting the main control virtual character 10 in aiming at a location. In some embodiments, the aiming reticle 40 is aligned with a target object in a first guidance form. For example, the aiming reticle 40 is aligned with the target object by using an arrowed ray. The target object may be any object, for example, a terrain or a building. In some embodiments, after the aiming reticle 40 is aligned with the to-be-captured virtual pet character 20, a capture probability is displayed around the virtual pet character 20. The capture probability is configured for indicating a probability that the main control virtual character 10 tames the virtual pet character 20. For example, if the capture probability is displayed as “38%”, the probability that the main control virtual character 10 successfully tames the virtual pet character 20 is 38%. The player may determine, based on the capture probability, whether to perform a next capture operation on the virtual pet character.

As shown in (b) in FIG. 2, a capture spell-casting effect executed by the main control virtual character 10 on the virtual pet character 20 and a taming effect corresponding to the virtual pet character 20 are displayed in response to a release operation on the capture prop control 30.

In some embodiments, the capture prop control is a first capture prop control, the first capture prop control corresponds to a first capture prop, and the first capture prop is of one of a plurality of prop types. In some embodiments, the main control virtual character 10 executes a first type of capture spell-casting effect. The first type of capture spell-casting effect is related to a prop type of the first capture prop.

For example, the first capture prop is an attack-type capture prop, and the first type of capture spell-casting effect is an attack-type spell-casting effect. The first capture prop is a feeding-type capture prop, and the first type of capture spell-casting effect is a feeding-type spell-casting effect. The first capture prop is a healing-type capture prop, and the first type of capture spell-casting effect is a healing-type spell-casting effect. The first capture prop is a hypnotic-type capture prop, and the first type of capture spell-casting effect is a hypnotic-type spell-casting effect. The first capture prop is an interaction-type capture prop, and the first type of capture spell-casting effect is an interaction-type spell-casting effect. The first capture prop is an attribute-counter-type capture prop, and the first type of capture spell-casting effect is an attribute-counter-type spell-casting effect.

In some embodiments, the capture prop control is a second capture prop control, and the second capture prop control corresponds to a second capture prop. In some embodiments, the main control virtual character 10 executes a first type of capture spell-casting effect. The second type of capture spell-casting effect is related to state information of the virtual pet character. In some embodiments, the state information of the virtual pet character includes at least one of an attribute, a personality, or a state of the virtual pet character.

For example, the personality of the virtual pet character is a combative personality, and the second type of capture spell-casting effect is an attack-type spell-casting effect. The state of the virtual pet character is an injured state, and the second type of capture spell-casting effect is a healing-type spell-casting effect. The state of the virtual pet character is a hungry state, and the second type of capture spell-casting effect is a feeding-type spell-casting effect. The attribute of the virtual pet character is dark attribute, and the second type of capture spell-casting effect is a light-type spell-casting effect. In some embodiments, different types of capture spell-casting effects have different display styles, and the display style of the capture spell-casting effect is related to the type. For example, the second type of capture spell-casting effect is the hypnotic-type spell-casting effect, and a display style corresponding to the hypnotic-type spell-casting effect is casting a hypnotic note. For another example, the second type of capture spell-casting effect is a fire-type spell-casting effect, and a display style of the fire-type spell-casting effect is throwing a fireball.

In some embodiments, the taming effect corresponding to the virtual pet character 20 is displayed in a process in which the main control virtual character 10 executes the capture spell-casting effect. In some embodiments, a gradual transition of the taming effect corresponding to the virtual pet character 20 from a first effect to a second effect is displayed, and an effect intensity of the second effect is higher than an effect intensity of the first effect. For example, in a process in which the main control virtual character 10 casts a spell by casting a hypnotic note, the virtual pet character 20 starts to be displayed in a dazed state, and as the main control virtual character 10 continues casting the spell, the virtual pet character 20 gradually transitions to a coma state. In some embodiments, a first progress is displayed around the virtual pet character 20, and the first progress is configured for indicating a taming progress of the virtual pet character 20. A representation form of the first progress may be at least one of a progress bar, a status bar, a buffer circle, or an icon.

The virtual pet character 20 is displayed in a successfully tamed state in response to the capture spell-casting effect executed by the main control virtual character 10 reaching a first spell-casting state. The first spell-casting state includes at least one of the following: spell-casting duration of the first type of capture spell-casting effect reaches first duration; an attack effect of the first type of capture spell-casting effect reaches a first attack effect; the taming progress of the virtual pet character 20 reaches the first progress; and combat power of the virtual pet character 20 is weakened to first combat power.

In some embodiments, a capture result of the virtual pet character 20 is displayed after the main control virtual character 10 executes the capture spell-casting effect. If the main control virtual character 10 successfully tames the virtual pet character 20, that is, the capture result is a capture success, one capture prop is consumed. If the main control virtual character 10 fails to successfully tame the virtual pet character 20, that is, the capture result is a capture failure, the capture prop is returned to the main control virtual character 10.

As shown in (c) in FIG. 2, in response to the virtual pet character 20 being in a successfully captured state, the successfully captured virtual pet character 20 is placed in a container prop 50, and success prompt information 60 is displayed on the client. The success prompt information 60 is configured for indicating that the virtual pet character 20 is successfully tamed. For example, the success prompt information 60 is displayed as “Capture successful”. In some embodiments, the virtual pet character 20 is added to a pet list control, the pet list control displays a pet control corresponding to at least one container prop 50, and the container prop is configured for accommodating the virtual pet character 20. In some embodiments, one container prop corresponds to a pet control of one tamed virtual pet character in the pet list control. The tamed virtual pet character 20 may be summoned in response to a trigger operation on the pet control, and the tamed virtual pet character 20 and the main control virtual character 10 are displayed as being located in a same camp. The player may control the tamed virtual pet character 20 to work for the main control virtual character 10, or control the tamed virtual pet character 20 to combat against an enemy virtual character.

The main control virtual character and at least one virtual pet character in a scene picture of the virtual world are displayed, and the player may determine, based on a requirement, whether to capture the virtual pet character. The release operation on the capture prop control is triggered to display the capture spell-casting effect of the main control virtual character on the virtual pet character. For example, the capture spell-casting effect may be a spell-casting effect determined based on any one piece of state information of the attribute, the personality, and the state of the virtual pet character. After the main control virtual character completes casting a spell on the virtual pet character, the capture result of the virtual pet character is displayed. This manner of capturing the virtual pet character by casting the spell simplifies operations of capturing the virtual pet character without considering impact of environmental factors on capture. In addition, different types of capture spell-casting effects are used based on the state information of the virtual pet character. Introduction of different capture spell-casting effects improves a success rate of capturing the virtual pet character.

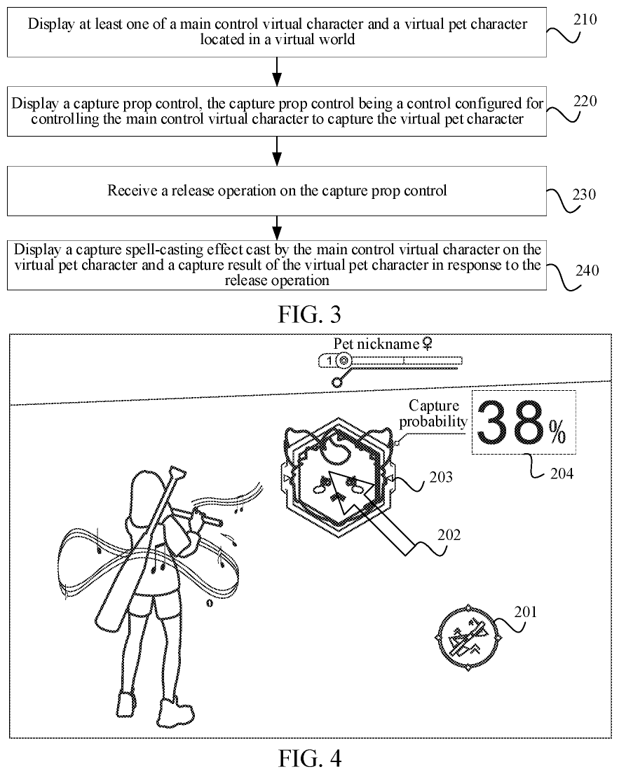

Referring to FIG. 3, a flowchart of a capture method based on a virtual world according to an embodiment of this disclosure is shown. The method is applied to the first terminal 120 shown in FIG. 1, or is applied to a client that supports a virtual world and that is installed on the first terminal 120. The method includes operation 210 to operation 240.
Operation 210: Display at least one of a main control virtual character or a virtual pet character located in the virtual world. In an example, a virtual main character and the virtual pet character are displayed in the virtual environment of a game application. The virtual main character is controlled by a user.

In some embodiments, a client supporting a virtual environment is run on a terminal device. A scene picture in which the main control virtual character is located in the virtual world is displayed on the client. The scene picture further includes at least one virtual pet character.

The main control virtual character is a virtual character playing an attacker role in a game. In some embodiments, the main control virtual character may be a virtual character controlled by a player, or the main control virtual character is a virtual character controlled by AI. This embodiment of this disclosure is described by using an example in which the main control virtual character is the virtual character controlled by the player. In some embodiments, the player participates in the game or interacts with the virtual environment by controlling the main control virtual character. A first account logged in to by the player by using the client has control permission on the main control virtual character.

The virtual pet character is a movable object in the virtual world. In some embodiments, the virtual pet character is at least one of a non-player character (NPC), a monster controlled by AI, a to-be-captured virtual pet character, or a combat character captured by a virtual character controlled by another player. In some embodiments, the virtual pet character may be displayed in any possible form. For example, a form of the virtual pet character is related to a level of the virtual pet character, an environment (weather, time, and a tile), a used prop, and the like.

In some embodiments, the virtual pet character may be the to-be-captured virtual pet character. In some embodiments, the main control virtual character may perform at least one of interactive operations such as capturing, raising, and upgrading on the virtual pet character. This is not limited in this disclosure. In some embodiments, the virtual pet character may assist the main control virtual character in, but not limited to, at least one of interactive operations such as collection, combating, and changing a tile. This is not limited in this disclosure.

In some embodiments, for the to-be-captured virtual pet character, the virtual pet character may be located at any possible location in the virtual world. The location of the virtual pet character may be associated with a type, an attribute, and the like of the virtual pet character. For example, the virtual pet character is a grass-type character, and is mostly distributed near a lawn, a jungle, and the like in the virtual world. The virtual pet character is a water-type character, and is mostly distributed near a lake, an ocean, and the like in the virtual world. The location of the virtual pet character may be randomly set.

In a possible implementation, the terminal displays the virtual environment by using a virtual environment picture. In some embodiments, the virtual environment picture is a picture in which the virtual environment is observed from the perspective of the main control virtual character. The perspective is an observation angle for observation in the virtual environment from a first-person perspective or a third-person perspective. In this embodiment of this disclosure, the perspective is an angle of observing the main control virtual character in the virtual environment by using a camera model. When the first-person perspective is used, the camera model is located near a head of the main control virtual character, or is located at a head of the main control virtual character. When the third-person perspective is used, the camera model may be located at the rear of the main control virtual character and bound to the main control virtual character, or may be located at any location apart from the main control virtual character by a first distance (the first distance may be a preset distance, or may be a distance flexibly adjusted as a scene changes). The main control virtual character located in the virtual environment may be observed from different perspectives by using the camera model. In some embodiments, in addition to the first-person perspective and the third-person perspective, the perspective further includes another perspective, for example, a top-down perspective. When the top-down perspective is used, the camera model may be located above the head of the main control virtual character. The top-down perspective is a perspective of observing the virtual environment from an angle of looking down in air. In some embodiments, the camera model is not actually displayed in the virtual environment, that is, the camera model is not displayed in the virtual environment displayed on a game interface.
Operation 220: Display a capture prop control, the capture prop control being a control configured for controlling the main control virtual character to capture the virtual pet character. In an example, a capture prop control element is displayed in a game interface of the game application. The capture prop control element is configured to control the virtual main character to initiate capture of the virtual pet character.

In some embodiments, the capture prop control is displayed on the game interface in response to a capture triggering operation. The capture triggering operation is an operation triggered by the player to initiate a battle with the to-be-captured virtual pet character, to capture the virtual pet character. The capture prop control is a control configured for controlling the main control virtual character to capture the virtual pet character.

In some embodiments, the capture prop control is an interface interaction element on the game interface that is configured for triggering a capture operation. In some embodiments, the capture prop control is usually presented in an icon, button, text, or another form. This is not limited in this disclosure. For example, the capture prop control may be a capture prop button.

In some embodiments, an aiming reticle corresponding to the capture prop control is displayed in response to a touch operation on the capture prop control. The aiming reticle assists the main control virtual character in aiming at a target object.

In some embodiments, the aiming reticle is a visual indicator. The aiming reticle that corresponds to the capture prop control and that is aligned with the target object in a first guidance form is displayed in response to the touch operation on the capture prop control. The first guidance form includes at least one of a ray, a dashed line, an arrow, an animation special effect, or a font. In some embodiments, the touch operation is an operation triggered on the capture prop control. For example, the touch operation is at least one of a plurality of operation forms such as a tap operation, a touch-and-hold operation, or a drag operation. The target object is an object with which the player aligns the aiming reticle, and may be any object in the virtual world, for example, a terrain, a unit (for example, another virtual character), or a building.

The foregoing content describes interface presentation content of displaying the aiming reticle based on the touch operation and aligning the aiming reticle with the target object in the first guidance form. Displaying the aiming reticle and aligning the aiming reticle with the target object in the first guidance form can enrich a presentation of the game interface by using a clear and simple design, guide the player to focus on a correct location, and improve operation accuracy and game experience of the player. In addition, the aiming reticle may be dynamically adjusted based on an operation of the player. This process can further help achieve higher precision of an aiming process, helping the player adjust an operation angle and an operation direction more pertinently, to improve a success rate of capturing the virtual pet character.

In some embodiments, a capture probability is displayed at a first surrounding location of the virtual pet character in response to an aiming operation on the virtual pet character, that is, the target object aligned with the aiming reticle being the to-be-captured virtual pet character. The aiming operation is an operation performed by the player to precisely capture the virtual pet character. In some embodiments, the aiming operation includes but is not limited to at least one of dragging the capture prop control, tapping the capture prop control, or double-tapping the capture prop control. This is not specifically limited in the implementations of this disclosure.

In some embodiments, the capture probability is configured for indicating a probability that the main control virtual character successfully tames the virtual pet character. In some embodiments, when the aiming reticle is aligned with the to-be-captured virtual pet character, the client reads the capture probability that the virtual pet character is successfully captured, and presents the capture probability at the first surrounding location of the virtual pet character in a percentage or in another form. The first surrounding location may be any location near the to-be-captured virtual pet character. For example, the first surrounding location may be the top-right, the bottom-right, the top-left, or the bottom-left of the virtual pet character. The first surrounding location is not specifically limited in this disclosure.

The foregoing content describes content of displaying the capture probability at the first surrounding location of the virtual pet character based on the aiming operation. Because the capture probability indicates the probability that the main control virtual character successfully tames the virtual pet character, different capture probabilities may be displayed at different aiming locations. The capture probability with quantitative nature can provide clearer aiming feedback for the player, improving interactivity and policy-based nature in the game. The capture probability that changes in real time with the aiming location can precisely feed back current difficulty in capture, helping improve the operation accuracy and immersion of the game, reduce difficulty in pet capture to some extent, and improve human-computer interaction efficiency.

In some embodiments, the capture probability is related to a state value of the virtual pet character. For example, the state value of the virtual pet character includes an energy value and a physical strength value of the virtual pet character. In some embodiments, the capture probability is in a negative correlation with the state value of the virtual pet character. In other words, a higher state value of the virtual pet character indicates a lower capture probability of the main control virtual character for the virtual pet character, and a lower state value of the virtual pet character indicates a higher capture probability of the main control virtual character for the virtual pet character. For example, when an energy value of a virtual pet character is 100, a corresponding capture probability is 30%; and when the energy value of the virtual pet character is 50, the corresponding capture probability is 60%.

In some embodiments, the capture probability is related to a state value of the main control virtual character. For example, the state value of the main control virtual character includes an energy value, a physical strength value, a health bar value, and level information of the main control virtual character. In some embodiments, the capture probability is in a positive correlation with the state value of the main control virtual character. In other words, a higher state value of the main control virtual character indicates a higher capture probability of the main control virtual character for the virtual pet character, and a lower state value of the main control virtual character indicates a lower capture probability of the main control virtual character for the virtual pet character.

In some embodiments, a capture probability threshold may be set based on the state value of the main control virtual character and/or the state value of the virtual pet character. The capture probability threshold is a value or a limit value for successfully capturing the virtual pet character. In some embodiments, when an actual capture probability is greater than the capture probability threshold, the probability that the main control virtual character successfully captures the virtual pet character is high. When the actual capture probability is less than or equal to the capture probability threshold, the probability that the main control virtual character successfully captures the virtual pet character is low. The capture probability threshold may be a specific value, or may be a range or a set of conditions. In some embodiments, the client compares the actual capture probability with the capture probability threshold, to prompt the player about a level of difficulty in capturing the virtual pet character.

For example, as shown in FIG. 4, a capture prop control 201 is displayed on the game interface. An aiming reticle 202 corresponding to the capture prop control 201 is displayed on the game interface in response to a touch operation on the capture prop control 201, for example, a tap on the capture prop control 201. The aiming reticle 202 is aligned with the target object in a guidance form of an arrow. The client reads a capture probability 204 of a virtual pet character 203 in response to an aiming operation on the virtual pet character 203, that is, aligning the aiming reticle 202 with the virtual pet character 203. For example, the capture probability of the virtual pet character 203 is 38%. The client presents the capture probability 204 on the right side of the virtual pet character 203 in a form of a percentage. The capture probability 204 is configured to indicate a probability that the virtual pet character 203 is successfully captured.

In this embodiment of this disclosure, the player may determine, based on the capture probability, whether to capture the virtual pet character. If the capture probability is high (greater than the capture probability threshold), the player may decide to capture the virtual pet character. If the probability is low (less than or equal to the capture probability threshold), the player may choose to give up or search for another pet object (another virtual pet character). Displaying the capture probability enables the player to adaptively adjust a capture policy.
Operation 230: Receive a release operation on the capture prop control.

The release operation is an operation configured for triggering the main control virtual character to execute a capture spell-casting effect. In some embodiments, an example in which a virtual key is displayed on a touchscreen is used. The release operation is at least one of operations such as a tap operation, a touch-and-hold operation, and a slide operation performed on the virtual key. Alternatively, the release operation is an operation of pressing a specified key on a physical gamepad or a keyboard. This is not limited in this disclosure.
Operation 240: Display the capture spell-casting effect cast by the main control virtual character on the virtual pet character and a capture result of the virtual pet character in response to the release operation. In an example, a release operation that is performed by the user on the capture prop control element is received. Based on the release operation, a capture effect on the virtual pet character is displayed, a capture result of the virtual pet character is determined, and the capture result of the virtual pet character is displayed.

In some embodiments, the capture spell-casting effect is a visual effect presented when the main control virtual character performs the capture operation. In some embodiments, the capture spell-casting effect acts on the virtual pet character. The main control virtual character executes different capture spell-casting effects for different virtual pet characters.

In some embodiments, the main control virtual character executes the capture spell-casting effect acting on the virtual pet character, and the virtual pet character displays a taming effect corresponding to the capture spell-casting effect. The taming effect is a visual effect presented when the virtual pet character is tamed. In some embodiments, the capture result of the virtual pet character is displayed when the main control virtual character completes executing the capture spell-casting effect. In some embodiments, the capture result of the virtual pet character includes two capture results: a capture success and a capture failure.

In an embodiment, the capture prop control is a consumption control configured to trigger consumption of a capture prop. A usage count of the capture prop is consumed in response to the release operation on the capture prop control.

In some embodiments, if the main control virtual character successfully tames the virtual pet character, that is, the capture result is the capture success, the capture prop is consumed, or the usage count of the capture prop is consumed. If the main control virtual character fails to successfully tame the virtual pet character, that is, the capture result is the capture failure, the capture prop is returned to the main control virtual character, or the usage count of the capture prop is restored. In an embodiment, the capture prop control is a consumption control for consuming the capture prop. For example, each time the capture prop control is triggered, the capture prop is consumed once. With the design of the consumption capture prop control, the player needs to consider timing and an effect of using the capture prop each time, enhancing policy thinking of the player during a game process. For example, the player cannot easily rely on a specific capture prop, but needs to properly use the capture prop at a key moment. The process improves a depth and interactivity of the game.

In some embodiments, a remaining quantity of times is displayed on the capture prop control. The remaining quantity of times may be displayed in at least one of a plurality of display forms such as a counter, an icon, or a progress bar, so that a remaining usage count of the capture prop may be clearly fed back. In some embodiments, the capture prop may alternatively be a prop that can be obtained in a virtual scene. For example, the player controls the main control virtual character to pick up the capture prop, redeems the capture prop in a manner of completing a specified task, or rewards the capture prop in a manner of completing a specified task. When the capture prop is obtained, the remaining quantity of times displayed on the capture prop control may increase, for example, change from “5” to “6”. Similarly, if the capture prop is consumed based on triggering of consumption of the capture prop, the displayed remaining quantity of times decreases, for example, changes from “6” to “5”.

The visual feedback enables the player to instantly know a state of a capture prop that the player possesses, and helps the player make a more intelligent decision. This avoids the capture prop being abused or overly relied on, and can also simplify implementation logic of using the capture prop, improving operation simplicity and maintainability.

According to the method provided in this embodiment, the main control virtual character and the at least one virtual pet character in the scene picture of the virtual world are displayed, and the player may determine, based on a requirement, whether to capture the virtual pet character. The release operation on the capture prop control is triggered to display the capture spell-casting effect of the main control virtual character on the virtual pet character. The capture prop control may be implemented as a consumption control. Therefore, after the main control virtual character completes casting a spell on the virtual pet character, the capture result of the virtual pet character is displayed. When the capture result is the capture success, the capture prop is consumed; or when the capture result is the capture failure, the capture prop is returned to the player. This manner of capturing the virtual pet character by casting the spell simplifies operations of capturing the virtual pet character without considering impact of environmental factors on capture, and improves a success rate of capturing the virtual pet character.

In some embodiments, the player controls the main control virtual character to execute the capture spell-casting effect acting on the virtual pet character, and completes capturing the virtual pet character by using the capture spell-casting effect. In some embodiments, the main control virtual character may determine a type of the capture spell-casting effect based on a type of the capture prop, or the main control virtual character may determine a type of the capture spell-casting effect based on state information of the virtual pet character. The following separately describes two cases of determining the type of the capture spell-casting effect.
First case: Determine the type of the capture spell-casting effect based on the type of the capture prop.
Second case: Determine the type of the capture spell-casting effect based on the state information of the virtual pet character.

### First Case: Determine the Type of the Capture Spell-Casting Effect Based on the Type of the Capture Prop

In some embodiments, the capture spell-casting effect acts on the virtual pet character. The main control virtual character executes different capture spell-casting effects for different capture props. In some embodiments, the capture prop control is a first capture prop control, the first capture prop control corresponds to a first capture prop, and the first capture prop is of one of a plurality of prop types.

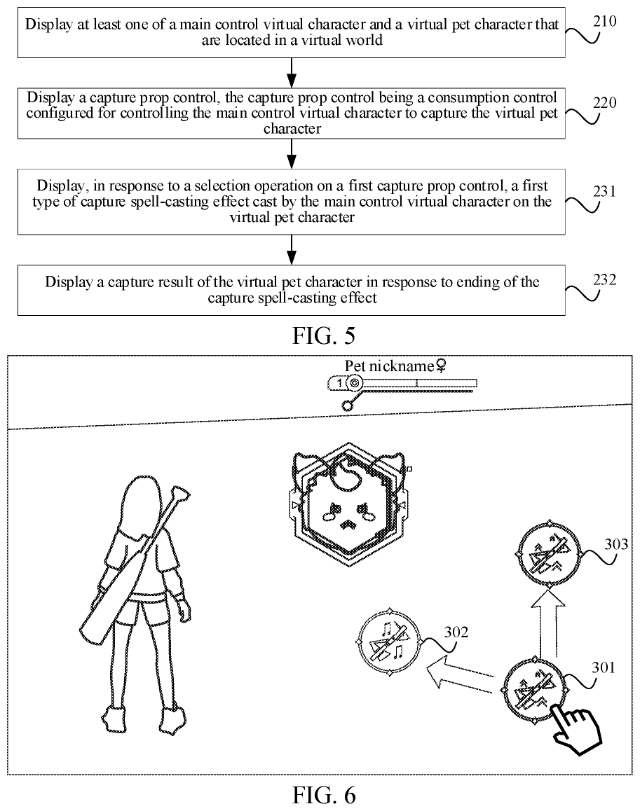

Referring to FIG. 5, a flowchart of a capture method based on a virtual world according to an embodiment of this disclosure is shown. Operation 230 and operation 240 may be replaced with operation 231 and operation 232.
Operation 231: Display, in response to a selection operation on the first capture prop control, a first type of capture spell-casting effect cast by the main control virtual character on the virtual pet character.

In some embodiments, the capture prop control is the first capture prop control, the first capture prop control corresponds to the first capture prop, and the first capture prop is of one of the plurality of prop types. The first capture prop control is a consumption control configured for controlling the main control virtual character to capture the virtual pet character. The first capture prop control is an interface interaction element on the game interface that is configured for triggering a capture operation. In some embodiments, the first capture prop control is usually presented in an icon, button, text, or another form. This is not limited in this disclosure. For example, the first capture prop control may be a capture prop button.

In some embodiments, the first type of capture spell-casting effect cast by the main control virtual character on the virtual pet character is displayed in response to the selection operation on the first capture prop control. The first type is related to a prop type of the first capture prop. In some embodiments, the prop type of the first capture prop includes at least one of an attack-type capture prop, a feeding-type capture prop, a healing-type capture prop, a hypnotic-type capture prop, an interaction-type capture prop, or an attribute-counter-type capture prop.

In some embodiments, the player activates a selection mode by touching and holding (or continuously touching) the first capture prop control, candidate options of a plurality of different types of capture props may be displayed on the game interface, and a first type of capture prop may be selected from the plurality of available candidate options. For example, the player browses different types of capture props in the plurality of available candidate options through a slide operation, views detailed information or effects of different types of capture props, and slides to the first type of capture prop to select the capture prop. For example, the candidate option is a prop option provided in advance for the player to select, and the first type is any selected prop type.

For example, as shown in FIG. 6, a first capture prop control 301 is displayed on the game interface. A first type of first capture prop control 302 and a second type of first capture prop control 303 are displayed around the first capture prop control 301 in response to a touch-and-hold operation on the first capture prop control 301. The player may select any one of the first type of first capture prop control 302 and the second type of first capture prop control 303 as required. For example, the player selects the second type of first capture prop control 303 through a slide-up operation.

In a possible implementation, the scene picture in which the main control virtual character is located in the virtual world is displayed on the game interface. The scene picture further includes the at least one virtual pet character. A plurality of candidate options of different types of capture props pop up from the virtual pet character in response to a trigger operation on the virtual pet character, and a first type of capture prop may be selected from the plurality of available candidate options.

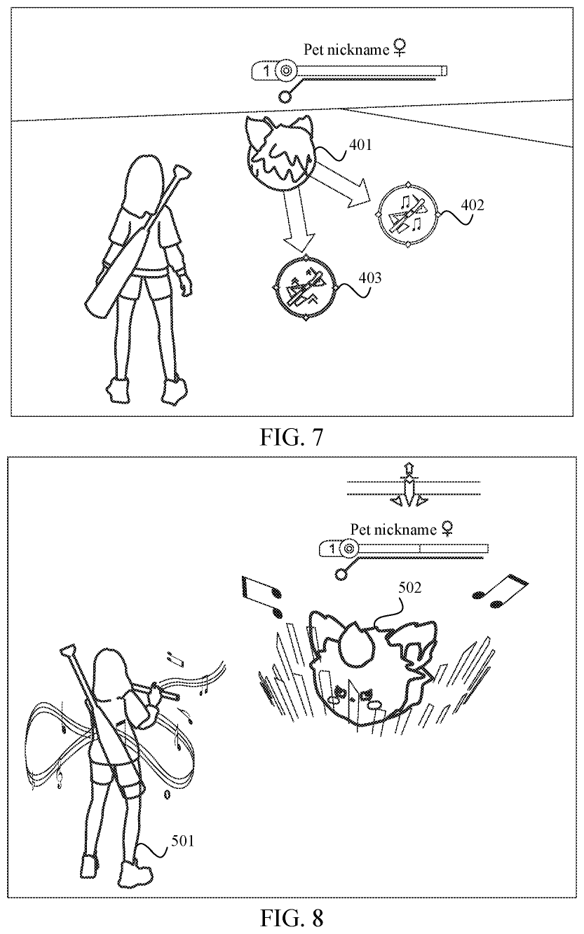

For example, as shown in FIG. 7, at least one virtual pet character 401 is displayed on the game interface. A first type of first capture prop control 402 and a second type of first capture prop control 403 pop up from the virtual pet character 401 in response to a tap operation on the virtual pet character 401. The player may select any one of the first type of first capture prop control 402 and the second type of first capture prop control 403 as required.

In some embodiments, the first type is related to the prop type of the first capture prop. The first type of capture spell-casting effect includes at least one of the following:
the first capture prop is an attack-type capture prop, and the first type of capture spell-casting effect is an attack-type spell-casting effect;
the first capture prop is a feeding-type capture prop, and the first type of capture spell-casting effect is a feeding-type spell-casting effect;
the first capture prop is a healing-type capture prop, and the first type of capture spell-casting effect is a healing-type spell-casting effect;
the first capture prop is a hypnotic-type capture prop, and the first type of capture spell-casting effect is a hypnotic-type spell-casting effect;
the first capture prop is an interaction-type capture prop, and the first type of capture spell-casting effect is an interaction-type spell-casting effect; and
the first capture prop is an attribute-counter-type capture prop, and the first type of capture spell-casting effect is an attribute-counter-type spell-casting effect.

In some embodiments, the attack-type capture spell-casting effect cast by the main control virtual character on the virtual pet character is displayed in response to a selection operation on the attack-type capture prop control. The attack-type capture prop is a prop configured for damaging the virtual pet character or applying a negative effect to the virtual pet character. The attack-type spell-casting effect is configured for damaging the virtual pet character or applying a negative state to the virtual pet character, and is applicable to a virtual pet character that needs to be captured or controlled by using force. For example, the attack-type capture prop is an explosive ball. An explosion may occur at a first location, causing an explosion damage to the virtual pet character. The first location may be a preset location point, may be a location point in contact with a virtual ground after the explosive ball is thrown, or the like.

In some embodiments, the feeding-type capture spell-casting effect cast by the main control virtual character on the virtual pet character is displayed in response to a selection operation on the feeding-type capture prop control. The feeding-type capture prop is a prop configured for providing a buff effect to the virtual pet character. The feeding-type spell-casting effect is configured for providing food or other resources to the virtual pet character, to address a hunger problem of the virtual pet character or improve friendliness of the virtual pet character. For example, the feeding-type capture prop may be an energy beverage or a special bait, and can attract attention of the virtual pet character, and increase the capture probability by satisfying an appetite of the virtual pet character.

In some embodiments, the healing-type capture spell-casting effect cast by the main control virtual character on the virtual pet character is displayed in response to a selection operation on the healing-type capture prop control. The healing-type capture prop is a prop configured for healing damage to the virtual pet character or eliminating a negative state of the virtual pet character. The healing-type spell-casting effect is configured for restoring health of the virtual pet character or relieving an injured state of the virtual pet character, and is applicable to a case in which the virtual pet character is injured or in a poor state. For example, the healing-type capture prop is a healing potion, and increases the capture probability by restoring a health value of the virtual pet character or healing an injury to the virtual pet character.

In some embodiments, the hypnotic-type capture spell-casting effect cast by the main control virtual character on the virtual pet character is displayed in response to a selection operation on the hypnotic-type capture prop control. The hypnotic-type capture prop is a prop configured for putting the virtual pet character into a sleep state or reducing alertness of the virtual pet character. The hypnotic-type spell-casting effect is configured for putting the virtual pet character into the sleep state, reducing resistance and mobility of the virtual pet character, and making it easier to capture the virtual pet character. For example, the hypnotic-type capture prop is a hypnotic note, and increases the capture probability by putting the virtual pet character into a temporary sleep state to reduce the mobility of the virtual pet character.

In some embodiments, the interaction-type capture spell-casting effect cast by the main control virtual character on the virtual pet character is displayed in response to a selection operation on the interaction-type capture prop control. The interaction-type capture prop is a prop configured for promoting interaction with or establishment of a relationship with a selected virtual pet character. The interaction-type spell-casting effect is configured for direct interaction with a pet, for example, stroking, communication, or training, to increase intimacy or friendliness with the virtual pet character and increase acceptance of the virtual pet character for capture. For example, the interaction-type capture prop is an interaction toy, and increases the capture probability by establishing contact with the virtual pet character to increase favorability of the virtual pet character to the main control virtual character.

In some embodiments, the attribute-counter-type capture spell-casting effect cast by the main control virtual character on the virtual pet character is displayed in response to a selection operation on the attribute-counter-type capture prop control. The attribute-counter-type capture prop is a prop configured for countering a specific attribute or reducing an attribute advantage of the virtual pet character. The attribute-counter-type spell-casting effect increases a capture success probability by applying an attribute-counter spell-casting effect by using an attribute-counter relationship of the virtual pet character. For example, the attribute-counter-type capture prop is an attribute weakening talisman, and increases a capture success rate according to an attribute counter principle.

The foregoing content describes content of displaying the corresponding first type of capture spell-casting effect based on the prop type of the first capture prop. Using the prop type as a condition for differential display of the capture spell-casting effect can provide richer image display, help provide more diversified interaction manners for the player to enhance the fun of the game, and help the player select a more appropriate virtual prop during the game process to improve fluency of game experience. In addition, setting an association between a prop type and a capture spell-casting effect facilitates flexible control and centralized management of a presentation of the capture spell-casting effect. The capture spell-casting effect indirectly assists the player in improving interaction efficiency in the virtual scene, achieving good technology scalability and ensuring human-computer interaction efficiency.

In a possible implementation, the first capture prop selected by the player is related to a level of the main control virtual character. The first capture prop is classified into a high-level-type capture prop and a low-level-type capture prop. In some embodiments, the type of the first capture prop selected by the player is in a positive correlation with the level of the main control virtual character. In other words, a higher level of the main control virtual character indicates a higher level of a first capture prop that may be selected. Alternatively, a quantity of first capture props selected by the player is in a positive correlation with the level of the main control virtual character. In other words, a higher level of the main control virtual character indicates a larger quantity of first capture props that may be selected. This is not limited in this disclosure.

For example, the feeding-type capture prop is a low-level-type capture prop, and the player can use the feeding-type capture prop when a level of the player is a level 1 to a level 10. The attribute-counter-type capture prop is a high-level-type capture prop. The player can use the hypnotic-type capture prop when the level of the player is upgraded to a level 15. The player may control the main control virtual character to execute a task to increase the level of the main control virtual character.

In some embodiments, an obtaining manner of the first capture prop includes but is not limited to at least one of the following:
obtaining based on the main control virtual character completing a specified task;
obtaining based on the main control virtual character reaching a first level for unlocking, where the first level may be implemented as a preset level, may be implemented as a level set by the player, may be implemented as a level flexibly allocated based on a historical battle situation of the main control virtual character, or the like;
obtaining through picking up by the main control virtual character in the virtual world;
obtaining as a gift from a teammate virtual character;
obtaining through purchasing by the main control virtual character from a store;
obtaining based on the main control virtual character interacting with the virtual pet character;
obtaining as a drop from the virtual pet character defeated by the main control virtual character;
obtaining through crafting from a raw material obtained by the main control virtual character; and
obtaining through crafting by the captured virtual pet character.

For example, an example in which the first capture prop is an attribute-counter-type capture prop is used for description. The attribute-counter-type capture prop may be obtained through crafting by the captured virtual pet character based on an attribute of the captured virtual pet character. For example, the main control virtual character successfully captures a virtual pet character with a fire attribute, the fire-type virtual pet character may craft a fire-type capture prop based on the attribute of the fire-type virtual pet character, and the fire-type capture prop may be used as a grass-attribute-counter-type capture crop to launch an attack on a virtual pet character with a grass attribute.

For example, an example in which the first capture prop is a feeding-type capture prop is used for description. The feeding-type capture prop may be obtained based on the main control virtual character interacting with the virtual pet character. For example, when the main control virtual character completes a task of feeding the virtual pet character, the feeding-type capture prop may be obtained.

For example, an example in which the first capture prop is an attack-type capture prop is used for description. The attack-type capture prop may be obtained as a drop from the virtual pet character defeated by the main control virtual character. For example, if the main control virtual character defeats a virtual pet character of a first level (for example, the first level is a preset level, or the first level is a level of any attacked virtual pet character), an attack-type capture prop of a first attack level may be obtained, and the attack-type capture prop of the same attack level may be configured for capturing a virtual pet character not higher than the first level. For example, if the main control virtual character defeats a virtual pet character whose level is 4, after the virtual pet character is defeated, a capture prop whose attack level is 4 is automatically dropped, and the capture prop whose attack level is 4 may be configured for capturing a virtual pet character whose level is less than or equal to 4.

The foregoing is merely an example description of the obtaining manner of the first capture prop. The obtaining manner of the first capture prop is not limited in this disclosure.

In this embodiment of this disclosure, the capture spell-casting effect is determined based on the type of the selected capture prop, and the player needs to adjust a capture policy based on different situations and select an appropriate capture spell-casting effect. Such a pertinent capture policy improves the capture success probability.

In some embodiments, different types of capture spell-casting effects have different display forms. In some embodiments, the display form of the capture spell-casting effect includes but is not limited to at least one of a light effect, a sound effect, an animation special effect, an energy fluctuation, a particle effect, or a magic circle pattern. This is not limited in this disclosure.

For example, the display form of the capture spell-casting effect is the light effect. During a spell-casting process, light or a beam may appear. Light effects of different colors and intensities represent capture of different types of virtual pet characters. For example, a red light effect is configured for capturing a fire-type virtual pet character, and a blue light effect is configured for capturing a water-type virtual pet character.

For example, the display form of the capture spell-casting effect is the energy fluctuation. In some embodiments, difficulty in capture and rarity of the virtual pet character are determined based on an intensity and a frequency of the energy fluctuation. For example, for a relatively common virtual pet character, the intensity and the frequency of the energy fluctuation are small; and for a relatively rare virtual pet character, the intensity and the frequency of the energy fluctuation are large. The energy fluctuation may be an aura, a ripple, or another form of energy representation surrounding the main control virtual character. For example, the display form of the capture spell-casting effect is the particle effect, and the main control virtual character may generate a spark, stardust, or another magic particle during the spell-casting process. In some embodiments, different types of particle effects may be associated with the attribute of the virtual pet character. For example, a capture spell-casting effect of a fire-type virtual pet character is displayed as flame particles, and a capture spell-casting effect of a water-type virtual pet character is displayed as waterdrop particles.

In some embodiments, the main control virtual character executes the capture spell-casting effect acting on the virtual pet character, and the virtual pet character displays a taming effect corresponding to the capture spell-casting effect. The taming effect is a visual effect presented when the virtual pet character is tamed.

FIG. 8 is a schematic diagram of a capture spell-casting effect according to an embodiment of this disclosure. As shown in FIG. 8, a capture spell-casting effect of a main control virtual character 501 is a hypnotic-type spell-casting effect. A display form of the hypnotic-type spell-casting effect is casting a hypnotic note. A symbol icon of the hypnotic note appears around the main control virtual character 501 and on a spell-casting path. A sound effect fluctuates during a spell-casting process, displaying transmission of the hypnotic note. The virtual pet character 502 is affected by the hypnotic note, and a corresponding taming effect is displayed. For example, a virtual pet character 502 is surrounded by the symbol icon of the hypnotic note, and light or a beam appears around the virtual pet character 502, indicating that the virtual pet character 502 is being tamed.

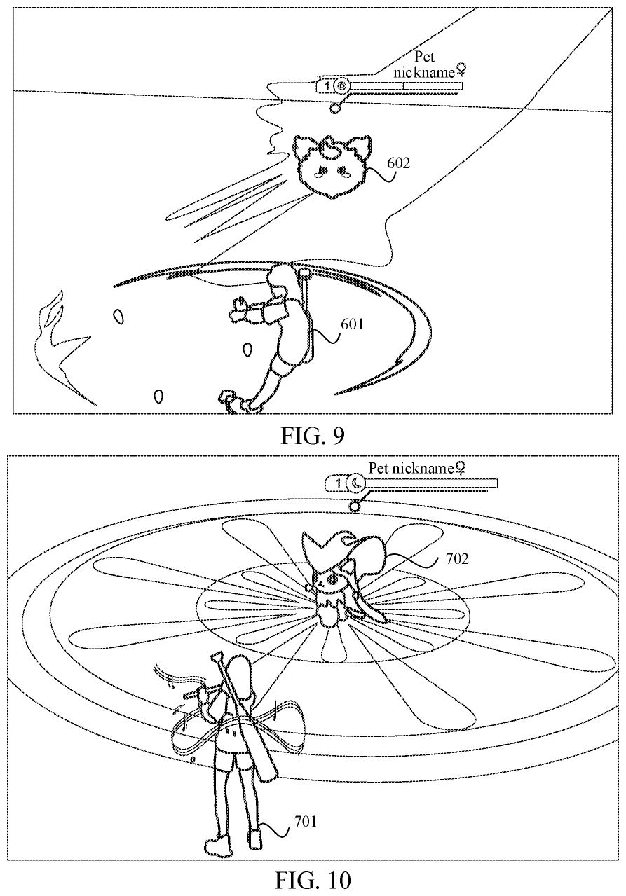

FIG. 9 is a schematic diagram of a capture spell-casting effect according to an embodiment of this disclosure. As shown in FIG. 9, a capture spell-casting effect of a main control virtual character 601 is an attack-type spell-casting effect. A display form of the attack-type spell-casting effect is a gale animation. A rotating wind flow and stone appear around the main control virtual character 601, showing a gale effect. A virtual pet character 602 is affected by the gale effect, and a corresponding taming effect is displayed. For example, the taming effect of the virtual pet character 602 is represented as the virtual pet character being surrounded by the wind flow, being in a floating state and cannot move freely, indicating that the virtual pet character 602 is being tamed.

FIG. 10 is a schematic diagram of a capture spell-casting effect according to an embodiment of this disclosure. As shown in FIG. 10, a capture spell-casting effect of a main control virtual character 701 is an attack-type spell-casting effect. A display form of the attack-type spell-casting effect is a magic circle pattern. The main control virtual character 701 is capturing a virtual pet character 702 by using a magic circle pattern-based capture skill. A large magic circle pattern with a luminous symbol and pattern appears on the ground, and a light effect is emitted around the magic circle pattern. The virtual pet character 702 is affected by the magic circle pattern, and a corresponding taming effect is displayed. For example, the virtual pet character 702 is displayed as located in the center of the magic circle pattern and is covered by the light effect, indicating that the virtual pet character 702 is being tamed.
Operation 232: Display a capture result of the virtual pet character in response to ending of the capture spell-casting effect.

In some embodiments, the capture result of the virtual pet character is displayed when the main control virtual character completes executing the capture spell-casting effect. In some embodiments, the capture result of the virtual pet character includes two capture results: a capture success and a capture failure. The capture success may also be referred to as a taming success, and the capture failure may be referred to as a taming failure.

In some embodiments, if the main control virtual character successfully tames the virtual pet character, that is, the capture result is the capture success, the first capture prop is consumed, or a usage count of the first capture prop is consumed. If the main control virtual character fails to successfully tame the virtual pet character, that is, the capture result is the capture failure, the first capture prop is returned to the main control virtual character, or the usage count of the first capture prop is restored.

According to the method provided in this embodiment of this disclosure, the type (for example, an attack type, a feeding type, a healing type, a hypnotic type, an interaction type, and an attribute-counter type) of the capture spell-casting effect is determined based on the type of the capture prop, and when capturing the virtual pet character, the player selects a capture prop as required and determine an appropriate capture policy, to implement personalized and dynamic capture, enhancing the interactivity in the game and the sense of participation of the player. This improves the interactivity and the policy-based nature in the game, making a capture process more interesting and challenging. The process also helps optimize resource utilization and improve operation efficiency of the player in the game process. The taming effect and the capture result that correspond to the virtual pet character are displayed in time, so that not only is interaction experience between the player and the virtual pet character enhanced, but also the human-computer interaction efficiency for the player in the game process is improved.

### Second Case: Determine the Type of the Capture Spell-Casting Effect Based on the State Information of the Virtual Pet Character

In some embodiments, the capture spell-casting effect acts on the virtual pet character. The main control virtual character executes different capture spell-casting effects for different virtual pet characters. In some embodiments, the main control virtual character determines the type of the capture spell-casting effect based on the state information of the virtual pet character. The state information of the virtual pet character includes at least one of a personality, a state, or an attribute of the virtual pet character.

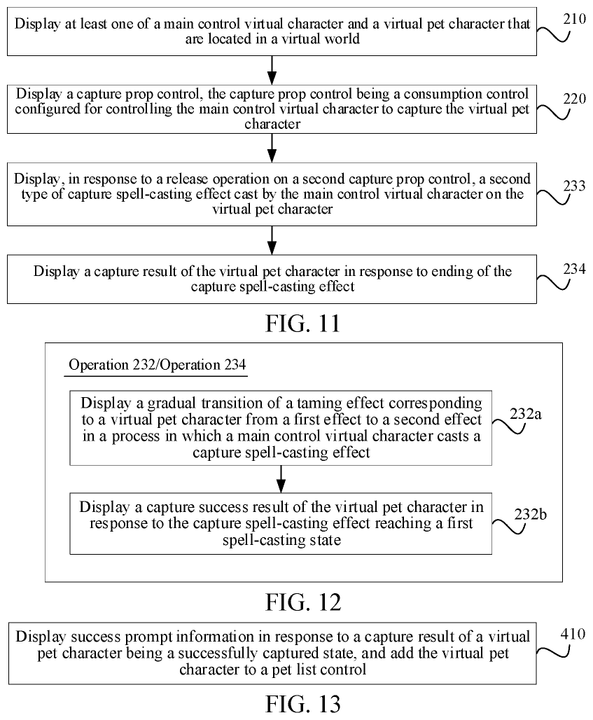

FIG. 11 is a flowchart of a capture method based on a virtual world according to an embodiment of this disclosure. Operation 230 and operation 240 may be replaced with operation 233 and operation 234.
Operation 233: Display, in response to a release operation on a second capture prop control, a second type of capture spell-casting effect cast by the main control virtual character on the virtual pet character.

In some embodiments, the capture prop control is the second capture prop control, and the second capture prop control corresponds to a second capture prop. The second capture prop control is a consumption control used by the main control virtual character to capture the virtual pet character. The second capture prop control is an interface interaction element on the game interface that is configured for triggering a capture operation. In some embodiments, the second capture prop control is usually presented in an icon, button, text, or another form. This is not limited in this disclosure. For example, the second capture prop control may be a capture prop button.

In some embodiments, in response to a selection operation on the second capture prop control, a usage count of the second capture prop is consumed, and the second type of capture spell-casting effect cast by the main control virtual character on the virtual pet character is displayed. The second type of capture spell-casting effect is related to the state information of the virtual pet character.

In some embodiments, the state information of the virtual pet character includes at least one of the personality, the state, or the attribute of the virtual pet character. In other words, the second type of capture spell-casting effect is determined based on the state information of the virtual pet character. The personality is configured for indicating a behavior characteristic and an inherent trait of the virtual pet character, and the personality may affect a behavior mode and a response manner of the pet. For example, the personality of the virtual pet character is combative, gentle, lively, timid, or the like. The state is configured for indicating a current physiological condition or psychological condition of the virtual pet character, and the state may affect a health level, an energy level, an emotional state, and the like of the virtual pet character. For example, the state of the virtual pet character is a hungry state or an injured state. The attribute is configured for indicating an element attribute of the virtual pet character. For example, the element attribute of the virtual pet character is fire, water, electricity, or darkness.

In some embodiments, the state information of the to-be-captured virtual pet character is first obtained, that is, at least one of the personality, the state, or the attribute of the virtual pet character is obtained. Then, the second type of capture spell-casting effect is selected based on the obtained state information of the virtual pet character.

In some embodiments, the second type of capture spell-casting effect includes at least one of the following:
the second type of capture spell-casting effect is an attack-type spell-casting effect;
the second type of capture spell-casting effect is a feeding-type spell-casting effect;
the second type of capture spell-casting effect is a healing-type spell-casting effect;
the second type of capture spell-casting effect is a hypnotic-type spell-casting effect;
the second type of capture spell-casting effect is an interaction-type spell-casting effect; and
the second type of capture spell-casting effect is an attribute-counter-type spell-casting effect.

In some embodiments, the attack-type spell-casting effect is configured for damaging the virtual pet character or applying a negative state to the virtual pet character, and is applicable to a virtual pet character that needs to be captured or controlled by using force. The feeding-type spell-casting effect is configured for providing food or other resources to the virtual pet character, to address a hunger problem of the virtual pet character or improve friendliness of the virtual pet character. The healing-type spell-casting effect is configured for restoring health of the virtual pet character or relieving an injured state of the virtual pet character, and is applicable to a case in which the virtual pet character is injured or in a poor state. The hypnotic-type spell-casting effect is configured for putting the virtual pet character into the sleep state, reducing resistance and mobility of the virtual pet character, and making it easier to capture the virtual pet character. The interaction-type spell-casting effect is configured for direct interaction with a pet, for example, stroking, communication, or training, to increase intimacy or friendliness with the virtual pet character and increase acceptance of the virtual pet character for capture. The attribute-counter-type spell-casting effect increases a capture success probability by applying an attribute-counter spell-casting effect by using an attribute-counter relationship of the virtual pet character.

In some embodiments, the state information includes the personality of the virtual pet character, and a correspondence between the personality of the virtual pet character and the second type of capture spell-casting effect includes at least one of the following:
the personality of the virtual pet character is a combative personality, and the second type of capture spell-casting effect is an attack-type spell-casting effect;
the personality of the virtual pet character is a gentle personality, and the second type of capture spell-casting effect is a feeding-type spell-casting effect;
the personality of the virtual pet character is a lively personality, and the second type of capture spell-casting effect is an interaction-type spell-casting effect; and
the personality of the virtual pet character is a timid personality, and the second type of capture spell-casting effect is a hypnotic-type spell-casting effect.

In some embodiments, the type of the capture spell-casting effect is related to the personality of the virtual pet character. For example, the personality of the virtual pet character is the combative personality, and the virtual pet character with the combative personality is usually highly aggressive and resistant. In this case, the second type of capture spell-casting effect used is an attack-type spell-casting effect. The attack-type spell-casting effect reduces combat power of the virtual pet character, so that the virtual pet character is more easily captured. For example, the personality of the virtual pet character is the gentle personality, and the virtual pet character with the gentle personality is usually friendly and easy to get close to. In this case, the second type of capture spell-casting effect used is a feeding-type spell-casting effect. For example, the personality of the virtual pet character is the lively personality, and the virtual pet character with the lively personality is usually easy to get close to. In this case, the second type of capture spell-casting effect used is an interaction-type spell-casting effect. For example, the interaction-type spell-casting effect is a stroking spell-casting effect, increasing acceptance of the virtual pet character for capture. For example, the personality of the virtual pet character is the timid personality, and the virtual pet character with the timid personality may be more likely to be startled or anxious, and is not easy to get close to. In this case, the second-type of capture spell-casting effect that may be used is a hypnotic-type spell-casting effect. The foregoing is merely an example. The correspondence between the personality of the virtual pet character and the type of the capture spell-casting effect is not limited in the embodiments of this disclosure.

In this embodiment of this disclosure, considering that the personality of the virtual pet character may affect performance enthusiasm of the virtual pet character in the game process, determining the capture spell-casting effect based on the personality of the virtual pet character can provide more personalized game experience for the player, increase the sense of participation of the player and emotional investment on the virtual pet character, and help the player more intuitively learn a personality of each virtual pet character and understand a corresponding spell-casting effect, improving operation cooperation efficiency of the player. In addition, displaying different capture spell-casting effects for different personalities also helps a developer perform more standardized management on different virtual pet characters, providing more immersive and flexible operation experience for the player and enhancing the immersion and fun of the game.

In some embodiments, the state information includes the state of the virtual pet character, and a correspondence between the state of the virtual pet character and the second type of capture spell-casting effect includes at least one of the following:
the state of the virtual pet character is a hungry state, and the second type of capture spell-casting effect is a feeding-type spell-casting effect;
the state of the virtual pet character is an injured state, and the second type of capture spell-casting effect is a healing-type spell-casting effect;
the state of the virtual pet character is an alert state, and the second type of capture spell-casting effect is a hypnotic-type spell-casting effect; and
the state of the virtual pet character is a combat state, and the second type of capture spell-casting effect is an attack-type spell-casting effect.

In some embodiments, the type of the capture spell-casting effect is further related to the state of the virtual pet character. For example, the state of the virtual pet character is the hungry state, and the virtual pet character in the hungry state needs to restore health. In this case, the second type of capture spell-casting effect used is a feeding-type spell-casting effect. This improves friendliness and acceptance of the virtual pet character, increasing the capture success rate. For example, the state of the virtual pet character is the injured state, and the virtual pet character in the injured state needs to restore health. In this case, the second type of capture spell-casting effect used is a healing-type spell-casting effect. For example, the health value is restored or an injury is healed, to improve the state of the virtual pet character, so that the virtual pet character is more easily captured. For example, the state of the virtual pet character is the alert state, and the virtual pet character in the alert state may become very alert and difficult to get close to. In this case, the second type of capture spell-casting effect used is a hypnotic-type spell-casting effect. For example, hypnotic notes are cast, so that the virtual pet character may be relaxed and enter a sleep state, reducing resistance of the virtual pet character. The foregoing is merely an example. The correspondence between the state of the virtual pet character and the type of the capture spell-casting effect is not limited in the embodiments of this disclosure.

In this embodiment of this disclosure, the capture spell-casting effect is determined based on the state of the virtual pet character, and the capture spell-casting effect is selected based on a current state of the virtual pet character, so that a relationship between the player and the virtual pet character may be improved, and the player can learn the state of the virtual pet character in time, enhancing policy-based nature and tactics in the game. The capture spell-casting effect matching the current state of the virtual pet character is selected, so that the virtual pet character can be protected to some extent or a capability of the virtual pet character can be maximized, the interaction experience between the player and the virtual pet character can be enhanced, the sense of participation of the player in the game process can be enhanced, and interaction efficiency in a game based on a virtual pet character can be improved.

In some embodiments, the state information includes the attribute of the virtual pet character, and a correspondence between the attribute of the virtual pet character and the second type of capture spell-casting effect includes at least one of the following:
the attribute of the virtual pet character is a fire attribute, and the second type of capture spell-casting effect is a water-counter-type spell-casting effect;
the attribute of the virtual pet character is a water attribute, and the second type of capture spell-casting effect is an ice-counter-type spell-casting effect;
the attribute of the virtual pet character is a grass attribute, and the second type of capture spell-casting effect is a fire-counter-type spell-casting effect; and
the attribute of the virtual pet character is a dark attribute, and the second type of capture spell-casting effect is a light-counter-type spell-casting effect.

In some embodiments, the type of the capture spell-casting effect is further related to the attribute of the virtual pet character. For example, the attribute of the virtual pet character is the fire attribute, and the pet with the fire attribute is relatively sensitive to a water-type spell. In this case, the second type of capture spell-casting effect used is an attribute-counter-type spell-casting effect. For example, a water-type spell-casting effect (a water attack) may be used to weaken a capability of the fire-type virtual pet character, so that the fire-type virtual pet character is more easily captured. For example, the attribute of the virtual pet character is the grass attribute, and the pet with the grass attribute is relatively sensitive to a fire-type spell. In this case, the second type of capture spell-casting effect used is an attribute-counter-type spell-casting effect. For example, a fire-type spell-casting effect may be used to quickly subdue the virtual pet character. The foregoing is merely an example. The correspondence between the attribute of the virtual pet character and the type of the capture spell-casting effect is not limited in the embodiments of this disclosure.

In this embodiment of this disclosure, the content of displaying the corresponding capture spell-casting effect based on the attribute of the virtual pet character is described. The capture spell-casting effect is displayed differently by using the attribute as a condition. This can clearly prompt the player about the attribute of the virtual pet character captured by the player, improve interface visibility and operation intuitiveness, and make the interaction experience of the player more vivid. In addition, respective attribute configurations of different virtual pet characters balance differences between different characters, improve fairness and challenge of the game, and help provide more diverse possibilities for the game process. The player can adjust a capture policy and select an appropriate capture spell-casting effect based on different situations. Such a pertinent capture policy increases the capture success probability and helps improve the human-computer interaction efficiency for the player.

In some embodiments, different types of capture spell-casting effects have different display forms. In some embodiments, the display form of the capture spell-casting effect includes but is not limited to at least one of a light effect, a sound effect, an animation special effect, an energy fluctuation, a particle effect, or a magic circle pattern. This is not limited in this disclosure.

For example, the display form of the capture spell-casting effect is the light effect. During a spell-casting process, light or a beam may appear. Light effects of different colors and intensities represent capture of different types of virtual pet characters. For example, a red light effect is configured for capturing a fire-type virtual pet character, and a blue light effect is configured for capturing a water-type virtual pet character.

For example, the display form of the capture spell-casting effect is the energy fluctuation. In some embodiments, an intensity and a frequency of the energy fluctuation are adjusted based on difficulty in capture and rarity of the virtual pet character. For example, for a relatively common virtual pet character, the intensity and the frequency of the energy fluctuation are small; and for a relatively rare virtual pet character, the intensity and the frequency of the energy fluctuation are large. The energy fluctuation may be an aura, a ripple, or another form of energy representation surrounding the main control virtual character.

For example, the display form of the capture spell-casting effect is the particle effect, and the main control virtual character may generate a spark, stardust, or another magic particle during the spell-casting process. In some embodiments, different types of particle effects may be associated with the attribute of the virtual pet character. For example, a capture spell-casting effect of a fire-type virtual pet character is displayed as flame particles, and a capture spell-casting effect of a water-type virtual pet character is displayed as waterdrop particles.

In some embodiments, the main control virtual character executes the capture spell-casting effect acting on the virtual pet character, and the virtual pet character displays a taming effect corresponding to the capture spell-casting effect. The taming effect is a visual effect presented when the virtual pet character is tamed. FIG. 8 is a schematic diagram of a capture spell-casting effect according to an embodiment of this disclosure. As shown in FIG. 8, a capture spell-casting effect of a main control virtual character 501 is a hypnotic-type spell-casting effect. A display form of the hypnotic-type spell-casting effect is casting a hypnotic note. A symbol icon of the hypnotic note appears around the main control virtual character 501 and on a spell-casting path. A sound effect fluctuates during a spell-casting process, displaying transmission of the hypnotic note. The virtual pet character 502 is affected by the hypnotic note, and a corresponding taming effect is displayed. For example, a virtual pet character 502 is surrounded by the symbol icon of the hypnotic note, and light or a beam appears around the virtual pet character 502, indicating that the virtual pet character 502 is being tamed.

FIG. 9 is a schematic diagram of a capture spell-casting effect according to an embodiment of this disclosure. As shown in FIG. 9, a capture spell-casting effect of a main control virtual character 601 is an attack-type spell-casting effect. A display form of the attack-type spell-casting effect is a gale animation. A rotating wind flow and stone appear around the main control virtual character 601, showing a gale effect. A virtual pet character 602 is affected by the gale effect, and a corresponding taming effect is displayed. For example, the taming effect of the virtual pet character 602 is represented as the virtual pet character being surrounded by the wind flow, being in a floating state and cannot move freely, indicating that the virtual pet character 602 is being tamed.

FIG. 10 is a schematic diagram of a capture spell-casting effect according to an embodiment of this disclosure. As shown in FIG. 10, a capture spell-casting effect of a main control virtual character 701 is an attack-type spell-casting effect. A display form of the attack-type spell-casting effect is a magic circle pattern. The main control virtual character 701 is capturing a virtual pet character 702 by using a magic circle pattern-based capture skill. A large magic circle pattern with a luminous symbol and pattern appears on the ground, and a light effect is emitted around the magic circle pattern. The virtual pet character 702 is affected by the magic circle pattern, and a corresponding taming effect is displayed. For example, the virtual pet character 702 is displayed as located in the center of the magic circle pattern and is covered by the light effect, indicating that the virtual pet character 702 is being tamed.
Operation 234: Display a capture result of the virtual pet character in response to ending of the capture spell-casting effect.

The second type of capture spell-casting effect is related to the state information of the virtual pet character. In some embodiments, the state information of the virtual pet character includes at least one of the personality, the state, or the attribute of the virtual pet character.

In some embodiments, the capture result of the virtual pet character is displayed when the main control virtual character completes executing the capture spell-casting effect. In some embodiments, the capture result of the virtual pet character includes two capture results: a capture success and a capture failure. The capture success may also be referred to as a taming success, and the capture failure may be referred to as a taming failure.

In some embodiments, if the main control virtual character successfully tames the virtual pet character, that is, the capture result is the capture success, the second capture prop is consumed, or the usage count of the second capture prop is consumed. If the main control virtual character fails to successfully tame the virtual pet character, that is, the capture result is the capture failure, the second capture prop is returned to the main control virtual character, or the usage count of the second capture prop is restored.

According to the method provided in this embodiment of this disclosure, a plurality of types of capture spell-casting effects (for example, an attack type, a feeding type, a healing type, a hypnotic type, an interaction type, and an attribute-counter type) are introduced, and when capturing the virtual pet character, the player needs to select an appropriate capture policy based on the state information (the personality, the state, and the attribute) of the virtual pet character, to implement personalized and dynamic capture, enhancing the interactivity in the game and the sense of participation of the player. This improves the interactivity and the policy-based nature in the game, making a capture process more interesting and challenging. The taming effect and the capture result that correspond to the virtual pet character are displayed in time, so that interaction experience between the player and the virtual pet character is enhanced.

### The Taming Effect of the Virtual Pet Character Gradually Transitions From a First Effect to a Second Effect

In some embodiments, the main control virtual character executes the capture spell-casting effect acting on the virtual pet character, and the virtual pet character displays a taming effect corresponding to the capture spell-casting effect. The taming effect is a visual effect presented when the virtual pet character is tamed. In some embodiments, the taming effect of the virtual pet character gradually transitions from the first effect to the second effect. For example, visual significance of the taming effect is gradually enhanced.

FIG. 12 is a flowchart of a capture method based on a virtual world according to an embodiment of this disclosure. Operation 232 or operation 234 may be replaced with operation 232a and operation 232b.
Operation 232a: Display a gradual transition of the taming effect corresponding to the virtual pet character from the first effect to the second effect in a process in which the main control virtual character casts the capture spell-casting effect.

The first effect and the second effect are taming effects presented in different phases or at different spell-casting degrees. In some embodiments, an effect intensity of the second effect is higher than an effect intensity of the first effect.

In some embodiments, the first effect is a taming effect presented at the start of capture, that is, the first effect is an initial state of the taming effect. The second effect is a taming effect presented after a period of time since the start of capture or after a spell-casting intensity of the capture spell-casting effect is increased, that is, the second effect is an intermediate state or an advanced state of the taming effect. In some embodiments, when the capture spell-casting effect reaches a specific level, the taming effect corresponding to the virtual pet character transitions from the first effect to the second effect that is more significant. That the capture spell-casting effect reaches a specific level means that spell-casting duration of the capture spell-casting effect or a spell-casting effect of the capture spell-casting effect reaches a specific level.

In some embodiments, the effect intensity of the second effect is higher than the effect intensity of the first effect. The effect intensity is significance of a visual effect. In some embodiments, the effect intensity includes but is not limited to at least one of a display size, display brightness, richness of display content, an animation presentation degree, or an interactivity intensity of a visual element.
The display size of the second effect is larger than that of the first effect.

In some embodiments, the display size is a size of the visual element or a size of occupied space. The visual element is a display element corresponding to the taming effect. When the taming effect is the first effect, the visual element (for example, an aura) may be small or concentrated. When the taming effect is the second effect, the visual element may have a larger size and a wider coverage range.
The display brightness of the second effect is higher than that of the first effect.

In some embodiments, the display brightness is brightness or a luminous intensity of the visual element. When the taming effect is the first effect, the virtual element may have low brightness and appear relatively gentle. For example, in this case, the taming effect is represented as a low-brightness light effect. When the taming effect is the second effect, the brightness increases, so that the visual element is more conspicuous. For example, in this case, the taming effect is represented as a high-brightness light effect.
The richness of the display content of the second effect is higher than that of the first effect.

In some embodiments, the richness of the display content is information or details included in the visual element. In some embodiments, higher richness of the display content indicates inclusion of more patterns, symbols, or animation elements in the taming effect. When the taming effect is the first effect, the visual element may be relatively simple. For example, the taming effect is displayed as only a basic light effect and particle effect. When the taming effect is the second effect, there may be richer visual elements. For example, the taming effect is displayed as including more types of particle effects and color changes.
The animation presentation degree of the second effect is higher than that of the first effect.

In some embodiments, the animation presentation degree is complexity, fluency, and expressiveness of an animation corresponding to the visual element. When the taming effect is the first effect, the animation may be relatively simple and slow. When the taming effect is the second effect, the animation becomes more complex, and includes more actions changing more frequently and fluently, so that the entire taming effect is more dynamic and vivid.
The interactivity intensity of the second effect is higher than that of the first effect.

In some embodiments, the interactivity intensity is a depth and responsiveness of interaction between the main control virtual character and the taming effect. When the taming effect is the first effect, the interactivity may be low. For example, the main control virtual character strokes the forehead of the virtual pet character. When the taming effect is the second effect, the interactivity is enhanced. For example, the main control virtual character strokes the forehead of the virtual pet character, and communicates with the virtual pet character.

The foregoing is merely an example description, and a display manner of the effect intensity may be any one of the foregoing display manners, or any combination of at least two display manners. This is not limited in this disclosure.
Operation 232b: Display a capture success result of the virtual pet character in response to the capture spell-casting effect reaching a first spell-casting state.

The first spell-casting state means that the main control virtual character executes the capture spell-casting effect until a preset condition is satisfied, to help ensure that the virtual pet character can be successfully tamed.

In some embodiments, the first spell-casting state includes at least one of the following:
spell-casting duration of the capture spell-casting effect reaches first duration, where the first duration may be default duration, may be duration configured by the player, or may be duration determined based on an object level of the main control virtual character;
an attack effect of the capture spell-casting effect reaches a first attack effect, where the first attack effect is usually a default attack effect, or may be an attack effect configured by the player, or the like;
a taming progress of the virtual pet character reaches a first progress, where the first progress is usually a default fixed progress value, may be a progress value determined based on the type of the virtual pet character, or may be a progress value determined based on an interaction relationship between the virtual pet character and the main control virtual character (for example, the progress value is small if the virtual pet character has ever interacted with the main control virtual character), or the like;
combat power of the virtual pet character is weakened to first combat power, where the first combat power is usually a default fixed combat power value, or may be a combat power value determined in real time based on a battle state of a virtual battle (for example, the first combat power is high at the start of the battle, and the first combat power is low at a middle moment of the battle), or the like.

In some embodiments, the first spell-casting state is configured for indicating that the spell-casting duration of the capture spell-casting effect reaches the first duration. The spell-casting duration is duration of the capture spell-casting effect. The first duration means that the duration of the capture spell-casting effect reaches a preset time length. In some embodiments, when the spell-casting duration of the capture spell-casting effect reaches the first duration, the capture spell-casting effect ends, and the capture result of the virtual pet character is displayed. For example, the capture spell-casting effect is a hypnotic-type spell-casting effect, and first spell-casting duration of the hypnotic-type spell-casting effect is 10 seconds. When the spell-casting duration of the hypnotic-type spell-casting effect executed by the main control virtual character reaches five seconds, the virtual pet character is in a dazed state. When the spell-casting duration of the hypnotic-type spell-casting effect reaches 10 seconds, the virtual pet character is in a coma state, that is, the first spell-casting state is reached.

In some embodiments, the first spell-casting state is configured for indicating that the attack effect of the capture spell-casting effect reaches the first attack effect. The attack effect is a damage value of the capture spell-casting effect. The first attack effect means that the capture spell-casting effect reaches a preset damage value. If the attack effect (for example, a damage or a state change) on the virtual pet character in the spell-casting process reaches the first attack effect, the first spell-casting state is triggered. For example, the capture spell-casting effect is an attack-type spell-casting effect. The main control virtual character executes the attack-type spell-casting effect on the virtual pet character. The first attack effect is that a health value of the virtual pet character is reduced to be less than 50%. When the main control virtual character continuously attacks the virtual pet character, and the health value of the virtual pet character is reduced to be less than 50%, the first spell-casting state is reached.

In some embodiments, the first spell-casting state is configured for indicating that the taming progress of the virtual pet character reaches the first progress. The taming progress is a progress degree to which the virtual pet character is tamed by the main control virtual character. The first progress means that the progress degree to which the virtual pet character is tamed by the main control virtual character reaches a first indicator. In some embodiments, the capture progress is displayed at a second surrounding location of the virtual pet character in a process in which the main control virtual character captures the virtual pet character. In some embodiments, a representation form of the capture progress includes but is not limited to at least one of a progress bar, a status bar, a buffer circle, or an icon. For example, the progress bar is displayed around the virtual pet character in the capture process, and the progress bar progresses from 0% to 100%, to display the capture progress degree.

The foregoing content describes content of displaying the capture progress at the first surrounding location of the virtual pet character. The capture progress can provide instant feedback to the player, helping the player better master a capture situation to adjust the pet capture policy. Displaying the progress bar around the virtual pet character can avoid interference to a main operating region of a player, improving intuitiveness of the capture state. This helps the player adjust the policy in different phases, improving playability and challenge of the game. In addition, calculation for display of the capture progress may be performed in real time based on usage of the capture prop by the main control virtual character, a state of the virtual pet character, an environmental factor, and the like. The progress bar or another visual element is dynamically updated to help provide the player with precise operation guidance, reducing an operation error, improving the success rate of capturing the virtual pet character, and improving the human-computer interaction efficiency.

In some embodiments, when the progress bar is completely filled, that is, reaches 100%, the capture progress of the virtual pet character reaches the first spell-casting state. In some embodiments, the first spell-casting state is configured for indicating that the combat power of the virtual pet character is weakened to the first combat power. The combat power is a combat capability or combat effectiveness of the virtual pet character. The first combat power means that the combat capability or the combat effectiveness of the virtual pet character is reduced to a minimum combat power threshold. In some embodiments, the combat power includes but is not limited to at least one of attack power, defense power, the health value, a health bar, or the energy value of the virtual pet character. For example, in the capture process, an initial health value of the virtual pet character is 100%, the minimum combat power threshold of the virtual pet character is 30%, and the main control virtual character continuously executes the capture spell-casting effect on the virtual pet character until the combat power of the virtual pet character is less than 30%, that is, the first spell-casting state is reached.

In this embodiment of this disclosure, a manner of reaching the first spell-casting state is set, for example, conditions that the spell-casting duration reaches the first duration, the attack effect reaches the first attack effect, the taming progress reaches the first progress, and the combat power of the virtual pet character is weakened to the first combat power are set, to help ensure that the capture operation is not completed on a random basis, but is implemented under a condition. Such a positive feedback mechanism can encourage the player to continue to invest in the game. Reaching the first spell-casting state through spell casting, attacking, capturing, and weakening of the combat power of the virtual pet character improves gameplay richness of the capture process and improves the game experience of the player. The first spell-casting state can also help ensure accuracy and fairness of the capture result.

According to this embodiment provided in this disclosure, the taming effect corresponding to the virtual pet character gradually transitions from the first effect to the second effect in the process in which the main control virtual character executes the capture spell-casting effect, so that the player can intuitively feel the progress and change of the capture process. In addition, such a gradual transition may further increase an expectation of the player on the capture success, and improves dynamism and policy-based nature of the game experience. When the capture spell-casting effect reaches the first spell-casting state, a successful taming result of the virtual pet character is displayed in the game. Such a display and feedback mechanism can enhance the sense of accomplishment and satisfaction of the player, and also guides the player to achieve an objective of capturing a pet through a task and a challenge in the game.

### The Capture Result of the Virtual Pet Character is a Successfully Captured State

In some embodiments, the capture result of the virtual pet character is displayed after the capture spell-casting effect executed by the main control virtual character on the virtual pet character is displayed. In some embodiments, when the capture result is the capture success, success prompt information is displayed, and the successfully captured virtual pet character is added to a pet list control,

[symbol]

FIG. 13 is a flowchart of a capture method based on a virtual world according to an embodiment of this disclosure. The method includes operation 410.
Operation 410: Display the success prompt information in response to the capture result of the virtual pet character being the successfully captured state, and add the virtual pet character to the pet list control,

[symbol]

In some embodiments, the success prompt information is displayed on the game interface in response to the capture result of the virtual pet character being the successfully captured state, the success prompt information being configured for indicating that the virtual pet character is successfully tamed. In some embodiments, a display form of the success prompt information includes but is not limited to at least one of a text, an icon, or an animation special effect. This is not specifically limited in this disclosure.

In some embodiments, a capture reward is further displayed on the game interface in response to the capture result of the virtual pet character being the successfully captured state. For example, the capture reward is increasing an experience point or unlocking a newly obtained skill. Alternatively, detailed information of the tamed virtual pet character, for example, a name, a category, a serial number, a skill, rarity, and a personality characteristic of the virtual pet character, is further displayed on the game interface.

In some embodiments, after the main control virtual character tames the virtual pet character, the tamed virtual pet character is added to the pet list control. The pet list control displays a pet control corresponding to at least one container prop, and the container prop is configured for accommodating the virtual pet character. In some embodiments, the container prop may implement at least one of functions of loading the virtual pet character, transmitting the virtual pet character, or healing the virtual pet character. A shape of the container prop includes but is not limited to at least one of a sphere, a square, a rectangle, a triangular cone, or a cylinder. This is not specifically limited in this disclosure.

In a possible implementation, the pet list control is displayed at a side location on the game interface in a listing manner. The listing manner means ordering and sequentially displaying an identifier corresponding to the container prop according to a listing rule. For example, three container props are arranged in the listing manner. Identifiers corresponding to the three container props are arranged in a pet list. Each container prop is configured for holding one tamed virtual pet character.

In some embodiments, the listing rule includes but is not limited to at least one of the following rules: randomly listing the container prop; listing the container prop based on an attribute of the container prop; listing the container prop based on a level of the virtual pet character in the container prop; and listing the container prop based on a level of the container prop.

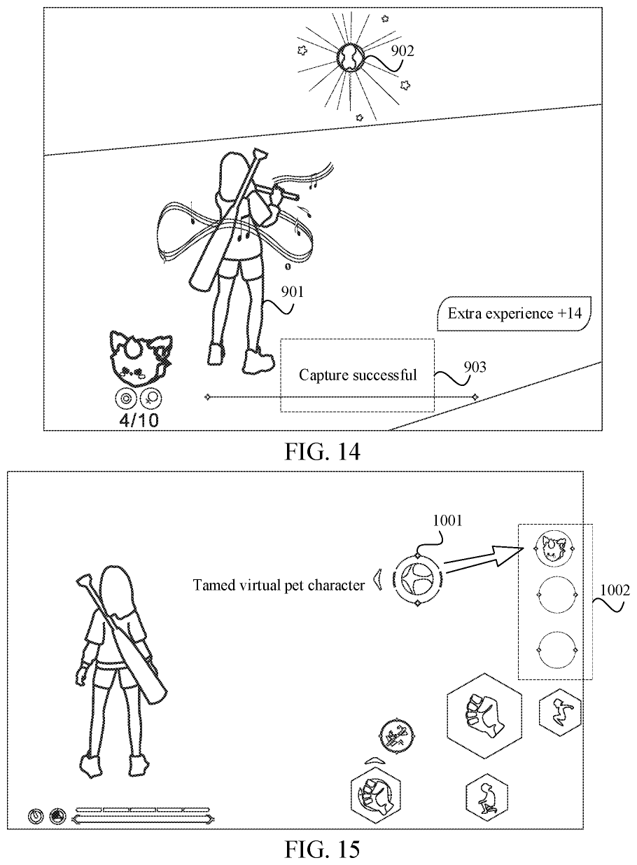

For example, as shown in FIG. 14, when a main control virtual character 901 executes the capture spell-casting effect until the first spell-casting state is reached, and the capture result of the virtual pet character is the successfully captured state, the successfully captured virtual pet character is placed in a container prop 902. The container prop 902 is configured for holding the successfully captured virtual pet character. In addition, success prompt information 903 is displayed on the game interface. For example, the success prompt information is displayed as “Capture successful”. The capture reward may be further displayed on the game interface. For example, the game reward is displayed as “Extra experience+14”. As shown in FIG. 15, the successfully captured virtual pet character is added to a pet list control 1002. In other words, a container prop 1001 that holds the successfully captured virtual pet character is added to the pet list control 1002. The pet list control 1002 displays controls corresponding to three container props for accommodating virtual pet characters.

In this embodiment of this disclosure, when the capture result of the virtual pet character reaches the successfully captured state, the corresponding success prompt information may be displayed in the game, to prompt the player about the current capture result. This can enhance the sense of accomplishment and satisfaction of the player, encourage the player to continue to capture another virtual pet character, and improve an interaction probability. In addition, the virtual pet character is added to the pet list control based on the successfully captured state, so that not only can the player be prompted intuitively to obtain the virtual pet character, but also in-time feedback of the capture result can be ensured, ensuring fluency of the game progress and data accuracy. In addition, the virtual pet character in the pet list control is dynamically updated, and the player can also clearly view and manage the successfully captured virtual pet character, further encouraging the player to explore the game, and enhancing the fun and player stickiness of the game.

In some embodiments, one container prop in the pet list control corresponds to a pet control of one successfully captured virtual pet character. In some embodiments, the successfully captured virtual pet character and the main control virtual character being located in a same camp is displayed in response to a trigger operation on the pet control. An interactive behavior of the successfully captured virtual pet character is displayed in response to a control operation on the successfully captured virtual pet character. The trigger operation on the pet control may be a trigger operation on a pet control corresponding to any container prop in the pet list control.

In some embodiments, the successfully captured virtual pet character corresponding to the pet control is summoned in response to the trigger operation on the pet control, and the successfully captured virtual pet character summoned and the main control virtual character are located in the same camp. The same camp is a character affiliation or a camp group in the virtual world. The successfully captured virtual pet character and the main control virtual character are located in the same camp, and have a same affiliation, are associated with each other, or support each other. The affiliation is a same team, alliance, or camp, or another form of affiliation relationship.

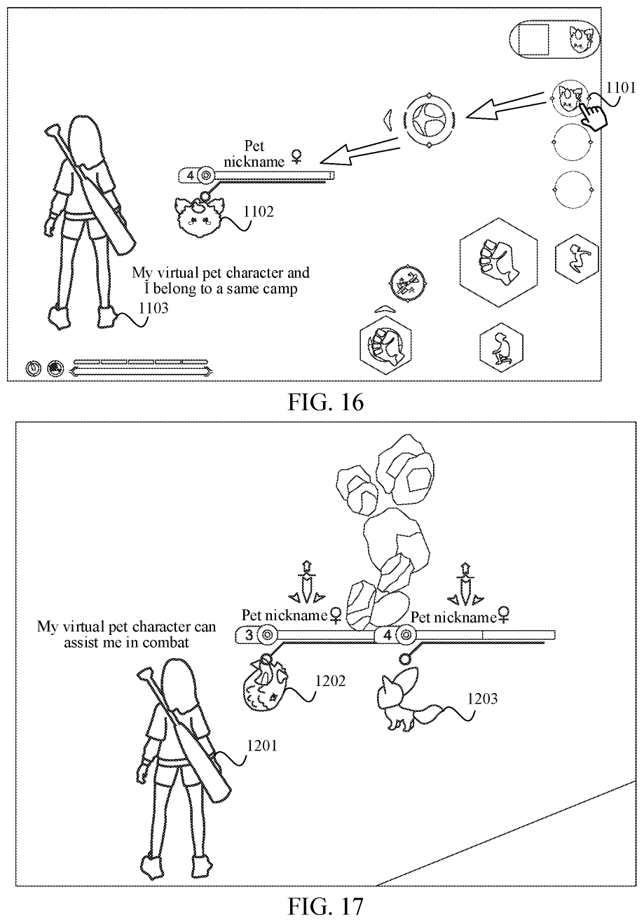

For example, as shown in FIG. 16, a successfully captured virtual pet character 1102 corresponding to a pet control 1101 is summoned in response to a trigger operation on the pet control 1101, and the successfully captured virtual pet character 1102 and a main control virtual character 1103 are located in a same camp.

In some embodiments, the interactive behavior of the tamed virtual pet character is displayed in response to the control operation on the successfully captured virtual pet character, The interactive behavior is an interaction manner between the main control virtual character and the successfully captured virtual pet character. In some embodiments, the interactive behavior includes but is not limited to at least one of the following manners:
an accompanying behavior of the virtual pet character;
an interactive action on the virtual pet character;
a combat behavior of the virtual pet character; and
the virtual pet character casting a special skill or effect.

In some embodiments, the interactive behavior is represented as the accompanying behavior of the virtual pet character, and the virtual pet character may follow the main control virtual character and exhibit a movement and a behavior that are similar to those of the main control virtual character. The interactive behavior is represented as the interactive action on the virtual pet character, and the main control virtual character may perform the interactive action with the virtual pet character, for example, feeding, stroking, and playing. The interactive behavior is represented as the combat behavior of the virtual pet character, and the main control virtual character may instruct the virtual pet character to combat against an enemy virtual character. The interactive behavior is represented as the virtual pet character casting the special skill or effect, and the virtual pet character may have a special capability or skill, for example, exploring, puzzle-solving, or enhancing a capability of the main control virtual character.

For example, as shown in FIG. 17, a main control virtual character 1201 and a successfully captured virtual pet character 1202 are located in a same camp. The main control virtual character 1201 controlling the successfully captured virtual pet character 1202 to combat again an enemy virtual character 1203 is displayed in response to a control operation on the successfully captured virtual pet character 1202.

In this embodiment of this disclosure, the successfully captured virtual pet character and the main control virtual character being located in the same camp is displayed, so that a relationship and cooperation between the successfully captured virtual pet character and the main control virtual character are enhanced. The main control virtual character performs the control operation on the successfully captured virtual pet character, and the interactive behavior between the main control virtual character and the virtual pet character is displayed, so that an interaction range in the game is expanded. The player may control the virtual pet character to perform a more pertinent and personalized operation, for example, instruct the virtual pet character to perform a specific task or action, increasing the policy-based nature and fun of the game.

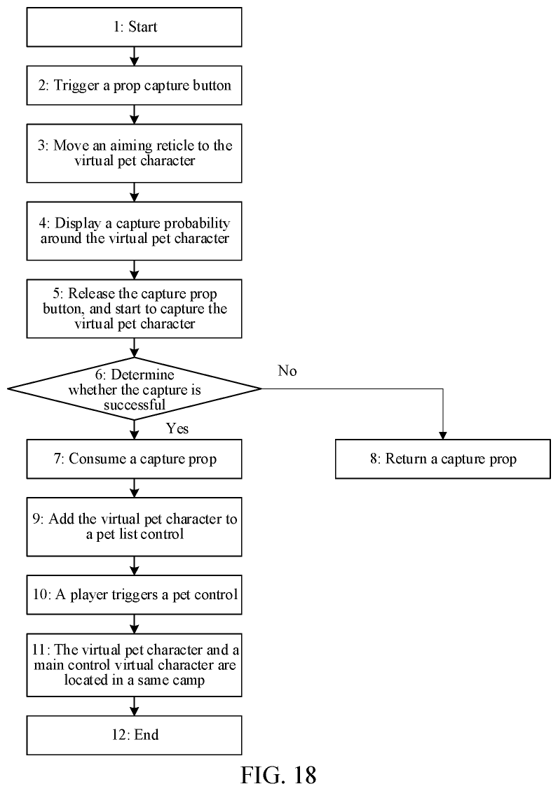

FIG. 18 is an overall flowchart of a capture method based on a virtual world according to an embodiment of this disclosure. Operations of the method may be performed by the first terminal device 120 or a client on the first terminal device 120 in the computer system shown in FIG. 1. The operations are as follows.
Operation 1: Start.

When a game starts, a scene picture in which a main control virtual character is located in the virtual world is displayed. The scene picture further includes at least one virtual pet character.
Operation 2: Trigger a capture prop button.

The capture prop button is displayed on a game interface. The capture prop button is a control configured for controlling the main control virtual character to capture the virtual pet character.

The client displays a virtual environment by using a virtual environment picture. The virtual environment picture is a picture in which the virtual environment is observed from the perspective of the main control virtual character. The perspective is an angle of observing the main control virtual character in the virtual environment by using a camera model.

In some embodiments, an aiming reticle corresponding to the capture prop control is displayed in response to triggering the capture prop button. After a player presses the capture prop button, the client switches a state of the camera model to an aiming mode in response to the trigger operation. The player may change the perspective to more precisely aim at or observe a to-be-captured object. In the aiming mode, the aiming reticle may appear on the game interface. The aiming reticle assists the main control virtual character in aiming at a target object. The target object is an object with which the player aligns the aiming reticle, and may be any object in the virtual world, for example, a terrain, a unit (for example, another virtual character), or a building.
Operation 3: Move the aiming reticle to the virtual pet character.

In some embodiments, the aiming reticle is moved to the to-be-captured virtual pet character in response to an aiming operation on the virtual pet character.

In some embodiments, the player may move the reticle by dragging the capture prop button (which may be a virtual button or a control on a touchscreen) on the screen, to adjust a focus of the camera model. Such an operation enables the player to accurately align the aiming reticle with the to-be-captured virtual pet character.
Operation 4: Display a capture probability around the virtual pet character.

In some embodiments, the target object aligned with the aiming reticle is the to-be-captured virtual pet character, and the capture probability is displayed at a first surrounding location of the virtual pet character. The capture probability is configured for indicating a probability that the main control virtual character successfully tames the virtual pet character. In some embodiments, when the aiming reticle is aligned with the to-be-captured virtual pet character, the client reads the capture probability that the virtual pet character is successfully captured, and presents the capture probability at the first surrounding location of the virtual pet character in a percentage or in another form. The player may determine, based on the capture probability, whether to capture the virtual pet character. Displaying the capture probability enables the player to adaptively adjust a capture policy.
Operation 5: Release the capture prop button, and start to capture the virtual pet character.

In some embodiments, the main control virtual character executing a capture spell-casting effect acting on the virtual pet character is displayed in response to a release operation on the capture prop button, and a capture result of the virtual pet character after the capture spell-casting effect is displayed. In some embodiments, the capture result of the virtual pet character includes two capture results: a capture success and a capture failure.

Capture of the virtual pet character starts to be performed in response to the release operation on the capture prop button. The client transmits a capture request to a server, including all related information of the capture operation, for example, data of the virtual pet character and the capture spell-casting effect of the main control virtual character.

In some embodiments, after receiving the capture request of the client, the server processes the capture operation according to game logic and a rule, and calculates the capture result. After completing processing, the server returns the capture result to the client.
Operation 6: Determine whether the capture is successful.
Operation 7: Consume a capture prop if the capture is successful.

If the capture is successful, that is, the capture result is the capture success, the server consumes the capture prop, and adds the captured virtual pet character to the pet list control.
Operation 8: Return the capture prop if the capture is unsuccessful.

If the capture is unsuccessful, that is, the capture result is the capture failure, the server notifies the client that the capture is unsuccessful, ends this round of capture procedure, does not consume the capture prop, and restores the state of the virtual pet character to a state before the capture, which may relate to restoring a health value of the virtual pet character or resetting a behavior mode of the virtual pet character.
Operation 9: Add the virtual pet character to a pet list control.

If the capture is successful, that is, the capture result is the capture success, the server adds the captured virtual pet character to the pet list control. The pet list control displays a pet control corresponding to at least one container prop, and the container prop is configured for accommodating the virtual pet character.

In some embodiments, information about the captured virtual pet character is added to the pet list control of the player, including information such as an identifier, a type, a level, an attribute, and a current state of the virtual pet character. The server updates data of an account of the player to reflect a new pet list control. The server transmits an operation result and the updated pet list control back to the client, and the client displays the newly captured virtual pet character.
Operation 10: The player triggers a pet control.

In some embodiments, one container prop in the pet list control corresponds to a pet control of one successfully captured virtual pet character. In some embodiments, the pet list control includes a first quantity of pet controls.
Operation 11: The virtual pet character and the main control virtual character are located in a same camp.

In some embodiments, the successfully captured virtual pet character corresponding to the pet control is summoned in response to the trigger operation on the pet control, and the successfully captured virtual pet character summoned and the main control virtual character are located in the same camp. The same camp is a character affiliation or a camp group in the virtual world.

In some embodiments, a summoning request is made in response to the trigger operation on the pet control. The client transmits the summoning request to the server. After receiving the summoning request, the server verifies whether the requested virtual pet character exists in the pet list control of the player. The server feeds back a result to the client, to confirm that the pet has been successfully generated and can interact with the player.

In some embodiments, an interactive behavior of the tamed virtual pet character is displayed in response to a control operation on the successfully captured virtual pet character, The interactive behavior is an interaction manner between the main control virtual character and the successfully captured virtual pet character.

For example, the interactive behavior is that the main control virtual character controls the successfully captured virtual pet character to combat against an enemy virtual character. The tamed virtual pet character recognizes the main control virtual character as a teammate, does not damage the main control virtual character, and cooperates with the main control virtual character to attack the enemy virtual character.
Operation 12: End.

### Beneficial Effects of This Solution

According to embodiments of this disclosure, a probability of a capture failure caused by a misoperation of the player and an objective factor is reduced. During capture, the player no longer needs to pay attention to various negative factors caused by occlusion of a path to the to-be-captured virtual pet character, a flight trajectory of a flying object, a quick movement of the virtual pet character, and the like. This reduces a thinking burden of the player, and reduces operations and time, improving the satisfaction of the player in the capture experience, and obtaining good benefits.

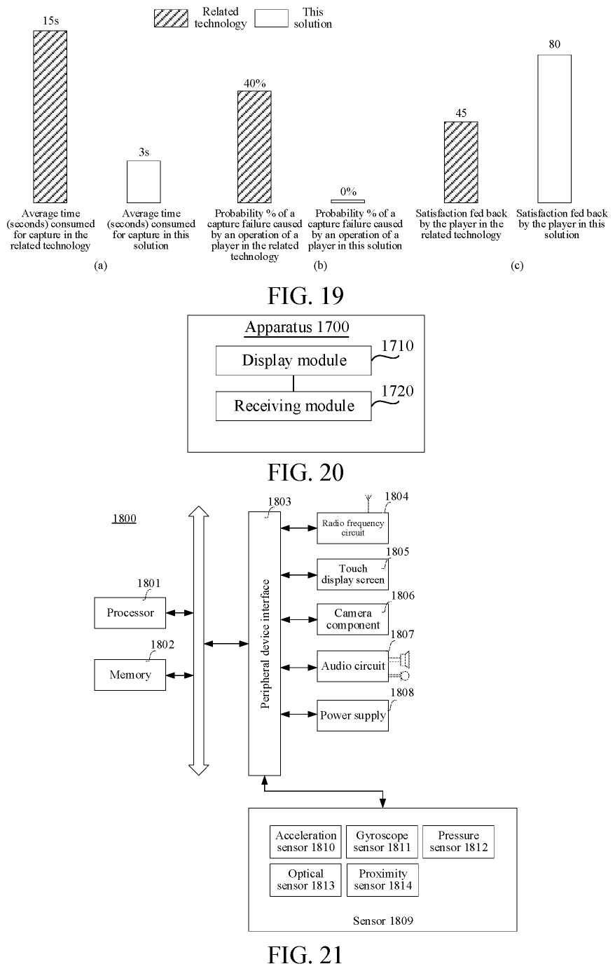

FIG. 19 is a diagram of comparison between results obtained in a related technology and this solution according to an embodiment of this disclosure. A game scenario is set with the following conditions: a distance between a to-be-captured virtual pet character and a main control virtual character is 20 meters, the to-be-captured virtual pet character is in a normal state, and a basic capture probability of the to-be-captured virtual pet character is 50%. As shown in (a) in FIG. 19, average time consumed for capturing a virtual pet character in the related technology is 15 seconds, and average time consumed for capturing a virtual pet character in this solution is 3 seconds. As shown in (b) in FIG. 19, a probability of a capture failure caused by a misoperation of a player in the related technology is 40%, and a probability of a capture failure caused by a misoperation of a player in this solution is 0%. As shown in FIG. (c) in FIG. 19, the satisfaction fed back by the player in the related technology is 45, and, the satisfaction fed back by the player in this solution is 80.

FIG. 20 is a block diagram of a structure of a capture apparatus based on a virtual world according to an embodiment of this disclosure. The apparatus has a function of implementing the foregoing capture method based on a virtual world. The function may be implemented by hardware, or may be implemented by hardware executing corresponding software. The apparatus may be the server described above, or may be disposed in the server. As shown in FIG. 20, the apparatus 1700 includes a display module 1710.

The display module 1710 is configured to display at least one of a main control virtual character or a virtual pet character located in the virtual world.

The display module 1710 is configured to display a capture prop control, the capture prop control being a control configured for controlling the main control virtual character to capture the virtual pet character.

A receiving module 1720 is configured to receive a release operation on the capture prop control.

The display module 1710 is configured to display a capture spell-casting effect cast by the main control virtual character on the virtual pet character and a capture result of the virtual pet character in response to the release operation.

In some embodiments, the capture prop control is a consumption control configured for triggering consumption of a capture prop.

The display module 1710 is further configured to consume a usage count of the capture prop in response to the release operation on the capture prop control.

In some embodiments, the display module 1710 further includes a display submodule.

In an example, the capture prop control is a first capture prop control, the first capture prop control corresponds to a first capture prop, and the first capture prop is of one of a plurality of prop types. The display submodule is configured to: in response to a selection operation on the first capture prop control, consume a usage count of the first capture prop control, and display a first type of capture spell-casting effect cast by the main control virtual character on the virtual pet character, the first type being related to a prop type of the first capture prop. The display submodule is configured to display the capture result of the virtual pet character in response to ending of the capture spell-casting effect.

In an example, the first type of capture spell-casting effect includes at least one of the following: the first capture prop is an attack-type capture prop, and the first type of capture spell-casting effect is an attack-type spell-casting effect; the first capture prop is a feeding-type capture prop, and the first type of capture spell-casting effect is a feeding-type spell-casting effect; the first capture prop is a healing-type capture prop, and the first type of capture spell-casting effect is a healing-type spell-casting effect; the first capture prop is a hypnotic-type capture prop, and the first type of capture spell-casting effect is a hypnotic-type spell-casting effect; the first capture prop is an interaction-type capture prop, and the first type of capture spell-casting effect is an interaction-type spell-casting effect; and the first capture prop is an attribute-counter-type capture prop, and the first type of capture spell-casting effect is an attribute-counter-type spell-casting effect.

In an example, the capture prop control is a second capture prop control, and the second capture prop control corresponds to a second capture prop. The display submodule is configured to: in response to a release operation on the second capture prop control, consume a usage count of the second capture prop, and display a second type of capture spell-casting effect cast by the main control virtual character on the virtual pet character, the second type of capture spell-casting effect being related to state information of the virtual pet character. The display submodule is configured to display the capture result of the virtual pet character in response to ending of the capture spell-casting effect, the state information including at least one of a personality, a state, or an attribute of the virtual pet character.

In an example, the state information includes the personality of the virtual pet character, and a correspondence between the personality of the virtual pet character and the second type of capture spell-casting effect includes at least one of the following: the personality of the virtual pet character is a combative personality, and the second type of capture spell-casting effect is an attack-type spell-casting effect; the personality of the virtual pet character is a gentle personality, and the second type of capture spell-casting effect is a feeding-type spell-casting effect; the personality of the virtual pet character is a lively personality, and the second type of capture spell-casting effect is an interaction-type spell-casting effect; and the personality of the virtual pet character is a timid personality, and the second type of capture spell-casting effect is a hypnotic-type spell-casting effect.

In an example, the state information includes the state of the virtual pet character, and a correspondence between the state of the virtual pet character and the second type of capture spell-casting effect includes at least one of the following: the state of the virtual pet character is a hungry state, and the second type of capture spell-casting effect is a feeding-type spell-casting effect; the state of the virtual pet character is an injured state, and the second type of capture spell-casting effect is a healing-type spell-casting effect; the state of the virtual pet character is an alert state, and the second type of capture spell-casting effect is a hypnotic-type spell-casting effect; and the state of the virtual pet character is a combat state, and the second type of capture spell-casting effect is an attack-type spell-casting effect.

In an example, the state information includes the attribute of the virtual pet character, and a correspondence between the attribute of the virtual pet character and the second type of capture spell-casting effect includes at least one of the following: the attribute of the virtual pet character is a fire attribute, and the second type of capture spell-casting effect is a water-counter-type spell-casting effect; the attribute of the virtual pet character is a water attribute, and the second type of capture spell-casting effect is an ice-counter-type spell-casting effect; the attribute of the virtual pet character is a grass attribute, and the second type of capture spell-casting effect is a fire-counter-type spell-casting effect; and the attribute of the virtual pet character is a dark attribute, and the second type of capture spell-casting effect is a light-counter-type spell-casting effect.

In an example, the display submodule is configured to display a gradual transition of a taming effect corresponding to the virtual pet character from a first effect to a second effect in a process in which the main control virtual character casts the capture spell-casting effect, an effect intensity of the second effect being higher than an effect intensity of the first effect. The display submodule is configured to display a capture success result of the virtual pet character in response to the capture spell-casting effect reaching a first spell-casting state.

In an example, the first spell-casting state includes at least one of the following: spell-casting duration of the capture spell-casting effect reaches first duration; an attack effect of the capture spell-casting effect reaches a first attack effect; a capture progress of the virtual pet character reaches a first progress; and combat power of the virtual pet character is weakened to first combat power.

In an example, the display submodule is configured to display, in response to a touch operation on the capture prop control, an aiming reticle corresponding to the capture prop control. The display submodule is configured to display a capture probability at a first surrounding location of the virtual pet character in response to an aiming operation on the virtual pet character, the capture probability being configured for indicating a probability that the main control virtual character successfully tames the virtual pet character.

In an example, the display submodule is configured to display, in response to the touch operation on the capture prop control, the aiming reticle that corresponds to the capture prop control and that is aligned with a target object in a first guidance form, the first guidance form including at least one of a ray, a dashed line, an arrow, an animation special effect, or a font.

In an example, the display submodule is configured to display the capture progress at a second surrounding location of the virtual pet character.

In an example, the display submodule is configured to display success prompt information in response to the capture result of the virtual pet character being a successfully captured state, and add the virtual pet character to a pet list control, the pet list control displaying a pet control corresponding to at least one container prop, and the container prop being configured for accommodating the virtual pet character.

In an example, the display submodule is configured to display, in response to a trigger operation on the pet control, the successfully captured virtual pet character and the main control virtual character being located in a same camp. The display submodule is configured to display an interactive behavior of the successfully captured virtual pet character in response to a control operation on the successfully captured virtual pet character, the interactive behavior including at least one of an accompanying behavior, an interactive action, a combat behavior, or casting a special skill.

For specific limitations in the foregoing one or more embodiments of the capture apparatus based on a virtual world, refer to the foregoing limitations on the capture method based on a virtual world. Details are not described herein again. The modules of the foregoing apparatus may be all or partially implemented by software, hardware, and a combination thereof. Each module may be embedded in or independent of a processor of a computer device in a form of hardware, or may be stored in a memory of a computer device in a form of software, for a processor to invoke to perform an operation corresponding to the module.

As used herein, the term “at least one of A, B, or C” or “one or more of A, B, or C” is intended to be interpreted as including: A alone, B alone, C alone, A and B together, A and C together, B and C together, or A, B, and C together. Similarly, “one of A and B” or “one of A or B” includes A, B, or both.

As used herein, a “module,” “unit,” or “submodule” may be implemented by processing circuitry, software modules executed by a processor, or a combination thereof. A software module may reside in any form of non-transitory computer-readable storage medium, such as RAM, flash memory, ROM, EPROM, EEPROM, registers, a hard disk, a removable disk, or a CD-ROM. A non-transitory computer-readable storage medium may be coupled to a processor such that the processor can read information from, and write information to, the non-transitory computer-readable storage medium. In the alternative, the non-transitory computer-readable storage medium may be integral to the processor.

The sequence numbers of the embodiments of this disclosure are merely for description and do not represent superiority-inferiority of the embodiments.

An embodiment of this disclosure further provides a computer device. The computer device includes a processor and a memory. The memory has at least one computer program stored therein. The at least one computer program is loaded and executed by the processor to implement the capture method based on a virtual world described in the foregoing method embodiments.

FIG. 21 is a block diagram of a structure of a computer device 1800 according to an embodiment of this disclosure. The computer device 1800 may be a portable mobile terminal. The computer device 1800 includes a processor 1801 and a memory 1802.

The processor 1801 may include one or more processing cores, for example, a four-core processor or an eight-core processor. The processor 1801 may be implemented in at least one hardware form of a digital signal processor (DSP), a field programmable gate array (FPGA), or a programmable logic array (PLA). The memory 1802 may include one or more computer-readable storage media. The computer-readable storage medium may be tangible and non-transitory. The memory 1802 may further include a high-speed random access memory and a non-volatile memory, for example, one or more disk storage devices or flash storage devices. In some embodiments, the computer device 1800 may further include a peripheral device interface 1803 and at least one peripheral device. The processor 1801, the memory 1802, and the peripheral device interface 1803 may be connected to each other through a bus or a signal cable. Each peripheral device may be connected to the peripheral device interface 1803 through a bus, a signal cable, or a circuit board. In an example, the peripheral device includes at least one of a radio frequency circuit 1804, a touch display screen 1805, a camera component 1806, an audio circuit 1807, or a power supply 1808. The peripheral device interface 1803 may be configured to connect at least one peripheral device related to input/output (I/O) to the processor 1801 and the memory 1802. The radio frequency circuit 1804 is configured to receive and transmit an RF signal, which is also referred to as an electromagnetic signal. The radio frequency circuit 1804 communicates with a communication network and another communication device by using the electromagnetic signal. The touch display screen 1805 is configured to display a user interface (UI). The UI may include graphics, text, icons, videos, or any combination thereof. The touch display screen 1805 also has a capability of acquiring a touch signal on or above a surface of the touch display screen 1805. The camera component 1806 is configured to acquire images or videos. In some embodiments, the camera component 1806 includes a front camera and a rear camera. The front camera is configured to implement a video call or self-portrait, and the rear camera is configured to shoot a picture or a video. The audio circuit 1807 is configured to provide an audio interface between a user and the computer device 1800. The audio circuit 1807 may include a microphone and a speaker. The microphone is configured to acquire sound waves of the user and an environment, convert the sound waves into an electric signal, and input the electric signal into the processor 1801 for processing, or input the electric signal into the radio frequency circuit 1804 for implementing voice communication. The power supply 1808 is configured to supply power to each component of the computer device 1800. The power supply 1808 may be alternating current, direct current, a primary battery, or a rechargeable battery. In some embodiments, the computer device 1800 further includes one or more sensors 1809. The one or more sensors 1809 include but are not limited to an acceleration sensor 1810, a gyroscope sensor 1811, a pressure sensor 1812, an optical sensor 1813, or a proximity sensor 1814. The acceleration sensor 1810 may detect acceleration on three coordinate axes of a coordinate system established by the computer device 1800. The pressure sensor 1812 may be disposed at a side frame of the computer device 1800 and/or a lower layer of the touch display screen 1805. When the pressure sensor 1812 is disposed at the side frame of the computer device 1800, a holding signal of the user on the computer device 1800 may be detected, and left and right hand recognition or a quick operation may be performed based on the holding signal. The optical sensor 1813 is configured to acquire an ambient light intensity. In an embodiment, the processor 1801 may control display brightness of the touch display screen 1805 based on the ambient light intensity acquired by the optical sensor 1813. The proximity sensor 1814, also referred to as a distance sensor, is disposed on a front surface of the computer device 1800. The proximity sensor 1814 is configured to acquire a distance between the user and the front surface of the computer device 1800. A person skilled in the art may understand that the foregoing structure does not constitute any limitation on the computer device 1800, and the computer device 1800 may include more components or fewer components than those shown in the figure, or some components may be combined, or a different component deployment may be used.

What is claimed is:

1. A method of capturing a virtual pet character in a virtual environment, the method comprising:
displaying a virtual main character and the virtual pet character in the virtual environment of a game application, the virtual main character being controlled by a user;
displaying a capture prop control element in a game interface of the game application, the capture prop control element being configured to control the virtual main character to initiate capture of the virtual pet character;
receiving a release operation that is performed by the user on the capture prop control element; and
based on the release operation,
displaying, by processing circuitry, a capture effect on the virtual pet character,
determining, by the processing circuitry, a capture result of the virtual pet character, and
displaying, by the processing circuitry, the capture result of the virtual pet character.

2. The method according to claim 1, further comprising:
reducing a remaining usage count of the capture prop element based on the release operation being performed on the capture prop control element.

3. The method according to claim 1, wherein
the capture prop control element corresponds to one of a plurality of capture props;
the displaying the capture effect includes displaying, based on the release operation on the capture prop control element, a first type of capture effect of a plurality of types of capture effect on the virtual pet character, the first type being determined to correspond to a prop type of the one of the plurality of capture props; and
the displaying the capture result includes displaying the capture result of the virtual pet character when the capture effect ends.

4. The method according to claim 3, wherein the first type of capture effect includes at least one of an attack-type spell-casting effect, a feeding-type spell-casting effect, a healing-type spell-casting effect, a hypnotic-type spell-casting effect, an interaction-type spell-casting effect, or an attribute-counter-type spell-casting effect.

5. The method according to claim 1, wherein
the capture prop control element corresponds to one of a plurality of capture props;
the displaying the capture effect includes displaying, based on the release operation on the capture prop control element, a second type of capture effect on the virtual pet character, the second type of capture spell-casting effect being determined based on character information of the virtual pet character; and
the displaying the capture result includes displaying the capture result of the virtual pet character when the capture effect ends.

6. The method according to claim 5, wherein
the character information includes a personality of the virtual pet character;
when the personality of the virtual pet character is a first personality, the second type of capture effect is an attack-type effect;
when the personality of the virtual pet character is a second personality, the second type of capture effect is a feeding-type effect;
when the personality of the virtual pet character is a third personality, the second type of capture effect is an interaction-type effect; and
when the personality of the virtual pet character is a fourth personality, the second type of capture effect is a hypnotic-type effect.

7. The method according to claim 5, wherein
the character information includes a state of the virtual pet character;
when the state of the virtual pet character is a first state, the second type of capture effect is a feeding-type effect;
when the state of the virtual pet character is a second state, the second type of capture effect is a healing-type effect;
when the state of the virtual pet character is a third state, the second type of capture effect is a hypnotic-type effect; and
when the state of the virtual pet character is a fourth state, the second type of capture effect is an attack-type effect.

8. The method claim 5, wherein
the character information includes an attribute of the virtual pet character;
when the attribute of the virtual pet character is a first attribute, the second type of capture effect is a water-counter-type effect;
when the attribute of the virtual pet character is a second attribute, the second type of capture effect is an ice-counter-type effect;
when the attribute of the virtual pet character is a third attribute, the second type of capture effect is a fire-counter-type effect; and
when the attribute of the virtual pet character is a fourth attribute, the second type of capture effect is a light-counter-type effect.

9. The method according to claim 3, wherein the displaying the capture result of the virtual pet character when the capture effect ends comprises:
displaying a gradual transition of a taming effect corresponding to the virtual pet character from a first effect to a second effect while the virtual main character casts the capture effect, an intensity of the second effect being higher than an intensity of the first effect; and
displaying a capture success result of the virtual pet character based on the capture effect reaching a first capture state.

10. The method according to claim 9, wherein the first capture state includes at least one of:
a duration of the capture effect reaches a first duration;
an attack effect of the capture effect reaches a first attack effect;
a capture progress of the virtual pet character reaches a first progress; or
a combat power of the virtual pet character is weakened to a first combat power.

11. The method according to claim 1, further comprising:
displaying, based on a touch operation on the capture prop control element, an aiming reticle; and
displaying a capture probability that the virtual main character successfully captures the virtual pet character based on an aiming operation on the virtual pet character.

12. The method according to claim 11, wherein the displaying, based on the touch operation on the capture prop control element, the aiming reticle comprises:
displaying, based on the touch operation on the capture prop control element, the aiming reticle in alignment with the virtual pet character in a guidance form.

13. The method according to claim 1, further comprising:
displaying a capture progress of the capture of the virtual pet character.

14. The method according to claim 1, further comprising:
displaying success notification information based on the capture result of the virtual pet character being a successfully captured state, and adding the virtual pet character to a pet list control interface,
the pet list control interface including a pet control element corresponding to at least one container prop configured to accommodate the virtual pet character.

15. The method according to claim 14, further comprising:
displaying, based on a selection operation on the pet control element, the successfully captured virtual pet character and the virtual main character being located in a same camp; and
controlling the successfully captured virtual pet character to perform an action based on a control operation performed by the user on the successfully captured virtual pet character.

16. An information processing apparatus, comprising:
processing circuitry configured to:
display a virtual main character and a virtual pet character in a virtual environment of a game application, the virtual main character being controlled by a user;
display a capture prop control element in a game interface of the game application, the capture prop control element being configured to control the virtual main character to initiate capture of the virtual pet character;
receive a release operation that is performed by the user on the capture prop control element; and
based on the release operation,
display a capture effect on the virtual pet character,
determine a capture result of the virtual pet character, and
display the capture result of the virtual pet character.

17. A non-transitory computer-readable storage medium storing instructions which, when executed by a processor, cause the processor to perform:
displaying a virtual main character and a virtual pet character in a virtual environment of a game application, the virtual main character being controlled by a user;
displaying a capture prop control element in a game interface of the game application, the capture prop control element being configured to control the virtual main character to initiate capture of the virtual pet character;
receiving a release operation that is performed by the user on the capture prop control element; and
based on the release operation,
displaying a capture effect on the virtual pet character,
determining a capture result of the virtual pet character, and
displaying the capture result of the virtual pet character.

18. The non-transitory computer-readable storage medium according to claim 17, further comprising:
reducing a remaining usage count of the capture prop control element based on the release operation being performed on the capture prop control element.

19. The non-transitory computer-readable storage medium according to claim 17, wherein
the capture prop control element corresponds to one of a plurality of capture props;
the displaying the capture effect includes displaying, based on the release operation on the capture prop control element, a first type of capture effect of a plurality of types of capture effect on the virtual pet character, the first type being determined to correspond to a prop type of the one of the plurality of capture props; and
the displaying the capture result includes displaying the capture result of the virtual pet character when the capture effect ends.

20. The non-transitory computer-readable storage medium according to claim 17, wherein
the capture prop control element corresponds to one of a plurality of capture props;
the displaying the capture effect includes displaying, based on the release operation on the capture prop control element, a second type of capture effect on the virtual pet character, the second type of capture spell-casting effect being determined based on character information of the virtual pet character; and
the displaying the capture result includes displaying the capture result of the virtual pet character when the capture effect ends.
